(19) United States
(12) Patent Application Publication
(10) Pub. No.: US 2014/0204108 A1
(43) Pub. Date: Jul. 24, 2014

(54) PIXEL CACHE, METHOD OF OPERATING PIXEL CACHE, AND IMAGE PROCESSING DEVICE INCLUDING PIXEL CACHE

(71) Applicant: SAMSUNG ELECTRONICS CO., LTD,, SUWON-SI (KR)

(72) Inventors: YOUNGIN CHUNG, SEONGNAM-SI (KR); JINHONG OH, HWASEONG-SI (KR)

(21) Appl. No.: 14/162,940

(22) Filed: Jan. 24, 2014

(30) Foreign Application Priority Data
Jan. 24, 2013 (KR) 10-2013-0008117

(51) Int. Cl. G06T 1/60

(52) U.S. Cl. CPC G06T 1/60
USPC 345/557

(57) ABSTRACT

A method of operating a pixel cache having a plurality of linefill units and configured to fetch an image stored in a main memory includes receiving a request for data of one or more image planes from a processor, and if the request for at least one image plane is determined as a “hit”, outputting the requested data of the at least one image plane and fetching the requested data from main memory of at one other image plane determined as not a “hit”. A “hit” is determined for each image plane of the one or more image planes based on whether data of the image plane is stored in one of the plurality of linefill units. The image plane may include at least two rows and at least two columns of pixels and has a size substantially identical to a capacity of the linefill unit.

### CROSS-REFERENCE TO RELATED APPLICATION

This non-provisional U.S. patent application claims priority under 35 U.S.C. §119 from Korean Patent Application No. 10-2013-0008117, filed on Jan. 24, 2013 in the Korean Intellectual Property Office, the contents of which are herein incorporated by reference in their entirety.

### BACKGROUND

1. Technical Field

Embodiments of the present disclosure are directed to a semiconductor apparatus, and more particularly, to a pixel cache, a method of operating pixel cache, and an image processing device including the pixel cache.

2. Discussion of the Related Art

An image processing device can perform various operations on an image acquired from a camera. With regard to an acquired image, an image processing device can perform operations such as noise reduction, stabilization, motion tracking, motion compensations, etc. As image processing devices have come to perform more operations that are more complicated, the support of these image processing operations has been the subject of research.

One line of research concerning the support of image processing operations is directed to a pixel cache. A pixel cache may be a memory embedded in an image processing device. A pixel cache can fetch and store data of an image stored in a main memory. If data required for an image is stored in a pixel cache, an image processing device may access the pixel cache to obtain data without accessing the main memory.

### SUMMARY

Embodiments of the present disclosure provide a pixel cache, a method of operating a pixel cache, and an image processing device including the pixel cache, which are optimized for image data management.

Embodiments of the inventive concept provide methods for operating a pixel cache that comprises a plurality of linefill units and is configured to fetch an image stored in a main memory, including receiving a request for data of one or more image planes from an image processing device, and if the request for at least one image plane is determined as a “hit”, outputting the requested data of the at least one image plane and fetching the requested data from the main memory of at one other image plane determined as not a “hit”. A “hit” is determined for each image plane of the one or more image planes based on whether data of the image plane is stored in one of the plurality of linefill units. The image may include at least two rows and at least two columns of pixels and has a size substantially identical to a capacity of the linefill unit.

In some embodiments, data of an image plane of the image stored in the main memory may be stored in one of the plurality of linefill units. Data of the image plane stored in the linefill unit is output to the image processing device, and the linefill unit is a unit of data stored or outputted at one time in the pixel cache.

In some embodiments, the image plane may be fetched to the linefill unit from at least two parts of the main memory, addresses of the at least two parts in the main memory may be non-consecutive, and each of the at least two parts may have at least two consecutive addresses in the main memory.

In some embodiments, the method may include outputting the fetched data of the at least one other image plane.

In some embodiments, the method may include receiving a request for two or more image planes from the image processing device.

In some embodiments, the request may include an address of a reference point related to the two or more image planes and a horizontal width from the reference point.

In some embodiments, the request may include an address of a reference point related to the two or more image planes and a vertical length from the reference point.

In some embodiments, the request may include an address of a reference point related to the two or more image planes and a horizontal width and a vertical length from the reference point.

In some embodiments, the request may include addresses of first and second reference points related to the two or more image planes.

In some embodiments, the two or more requested image planes are adjacent in the image.

In some embodiments, the method may further include, before storing data, adjusting a capacity of the linefill unit.

In some embodiments, the method may further include, before storing data, partitioning the plurality of linefill units into a first linefill group and a second linefill group.

In some embodiments, storing data may include storing data of a first image plane of a first image into a first linefill unit of the first linefill group, and storing data of a second image of a second image different from the first image into a second linefill unit of the second linefill group. Storing data into the first linefill unit and storing data into the second linefill unit may be simultaneously performed.

In some embodiments, if the request for a first image plane is determined as not a “hit,” the requested data of the first image plane is fetched from the main memory while receiving a request for data of a second image plane from the image processing device.

In some embodiments of the inventive concept, pixel caches are provided, which include a data memory that includes a plurality of frames, each frame including a plurality of linefill units that store data, a tag memory that includes a plurality of tag frames respectively corresponding to the plurality of the frames, each tag frame including a plurality of tag lines respectively corresponding to the plurality of linefill units of each frame, and a miss control unit for requesting an image plane of an image stored in an external main memory. Data of an image plane received from the main memory may be stored in a linefill unit of the data memory. Address information of the image plane received from the main memory may be stored in a tag line of the tag memory. A capacity of the linefill unit may correspond to a size of the image data being stored or outputted at one time in the pixel cache. The image plane may include at least two rows and at least two columns of pixels and have a size substantially identical to the capacity of the linefill unit.

In some embodiments, the pixel cache may include a register for storing information on the capacity of the linefill unit. The capacity of the linefill unit may be adjusted according to the information stored in the register.

In some embodiments, if the capacity of the linefill unit is to be increased, at least two linefill units from at least two different frames of the tag memory may be combined to form a combined linefill unit.

In some embodiments, the pixel cache may further include a register for storing information on a number of images being simultaneously processed. The miss control unit may simultaneously request from the main memory a number of image planes that respectively correspond to the number of images.

In some embodiments, the pixel cache may further include a hit and miss determination unit for receiving a request for data of a first image plane from an image processing device, and for determining whether the requested data of the first image plane exists in the data memory by searching the tag memory, and a register storing a request determined as “miss” request by the hit and miss determination unit. The miss control unit may request data of a second image plane from the main memory according to the miss request stored in the register. After the miss request is stored in the register, the hit and miss determination unit may receive a request for data of a next image plane and determine whether the requested data of the next image plane exists in the data memory.

In some embodiments, the pixel cache may further include a second register for storing a request determined as a “hit” request by the hit and miss determination unit while the miss control unit requests the data of the second image plane to the main memory.

In still other embodiments of the inventive concept, image processing devices may be provided, which include a pixel cache, and a processing unit for requesting data of an image plane from the pixel cache and for performing image processing on the data of the image plane received from the pixel cache. The pixel cache may include data memory that includes a plurality of frames, each frame including a plurality of linefill units for storing data, a tag memory that includes a plurality of tag frames that respectively correspond to the plurality of frames, each tag frame including a plurality of tag lines that respectively correspond to the plurality of linefill units of each frame, and a miss control unit for requesting data of the image plane from an external main memory according to the request from the processing unit. The image plane data received from the main memory may be stored in a linefill unit of the data memory, and address information of the image plane data received from the external main memory is stored in a tag line of the tag memory. A capacity of the linefill unit may correspond to a size of an image data being stored or outputted at one time in the pixel cache. The image plane may include at least two rows and at least two columns of pixels and has a size substantially identical to the capacity of the linefill unit.

### BRIEF DESCRIPTION OF THE DRAWINGS

FIG. 1 is a block diagram of a mobile apparatus in accordance with an embodiment of the inventive concept.

FIG. 2 is a flowchart of a method of processing a pixel cache in accordance with an embodiment of the inventive concept.

FIG. 3 illustrates an example where a pixel cache fetches image data stored in a main memory.

FIG. 4 illustrates another example where a pixel cache fetches image data stored in a main memory.

FIG. 5 is a block diagram of a pixel cache according to an embodiment of the inventive concept.

FIG. 6 is a flowchart of an example of a method of processing the pixel cache shown in FIG. 5.

FIG. 7 illustrates an example of an image plane and requested data.

FIG. 8 is a flowchart of another example of a method of operating the pixel cache shown in FIG. 5.

FIG. 9 illustrates an example of how a pixel cache receives a request for two or more image planes.

FIG. 10 illustrates an example of how a pixel cache outputs requested data in response to the request in FIG. 9.

FIG. 11 illustrates another example of how a pixel cache receives a request for two or more image planes.

FIG. 12 illustrates another example of how a pixel cache receives a request for two or more image planes.

FIG. 13 illustrates an example of how a pixel cache outputs requested data in response to the request shown in FIG. 12.

FIG. 14 illustrates another example of how a pixel cache receives a request for two or more image planes.

FIG. 15 illustrates another example of how a pixel cache receives a request for two or more image planes.

FIG. 16 illustrates an example of how a pixel cache outputs requested data in response to the request shown in FIG. 15.

FIG. 17 illustrates another example of how a pixel cache receives a request for two or more image planes.

FIG. 18 illustrates another example of how a pixel cache receives a request for two or more image planes.

FIG. 19 illustrates another example of how a pixel cache receives a request for two or more image planes.

FIG. 20 is a block diagram of a pixel cache according to another embodiment of the inventive concept.

FIG. 21 is a flowchart of a method of operating the pixel cache shown in FIG. 20.

FIG. 22 shows an example where a data memory is managed together with control of the size of a linefill unit.

FIG. 23 shows a table describing the processing unit size of a master apparatus and the size of a linefill unit.

FIG. 24 is a block diagram of a pixel cache according to another embodiment of the inventive concept.

FIG. 25 is a flowchart of a method of operating the pixel cache shown in FIG. 24.

FIG. 26 is a block diagram of a pixel cache according to another embodiment of the inventive concept.

FIG. 27 is a flowchart of a method of operating the pixel cache shown in FIG. 26.

FIG. 28 is a flowchart illustrating in more detail a method of operating the pixel cache shown in FIG. 26.

FIG. 29 is a block diagram of a pixel cache according to another embodiment of the inventive concept.

FIG. 30 is a block diagram of a pixel cache according to another embodiment of the inventive concept.

### DETAILED DESCRIPTION OF EXEMPLARY EMBODIMENTS

Exemplary embodiments of the inventive concept will be described below in more detail with reference to the accompanying drawings. Embodiments of the inventive concept may, however, be embodied in different forms and should not be construed as limited to the embodiments set forth herein.

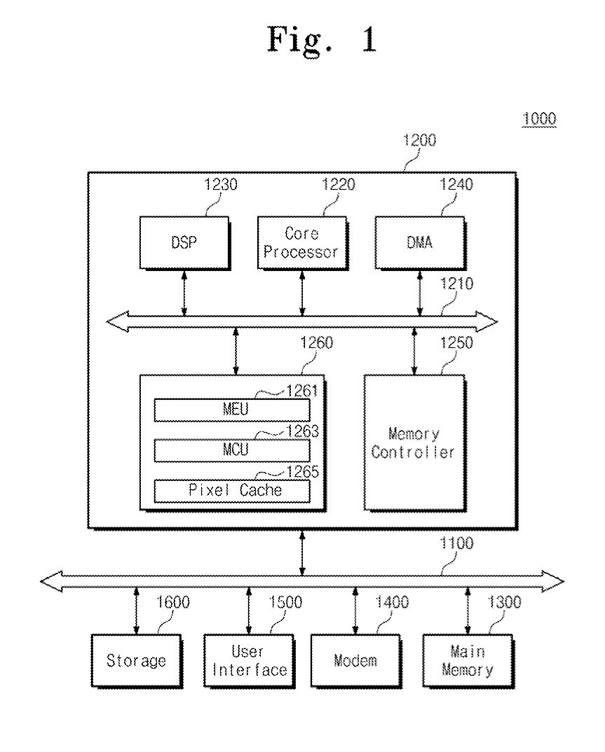

FIG. 1 is a block diagram of a mobile apparatus in accordance with an embodiment of the inventive concept. Referring to FIG. 1, a mobile apparatus 1000 includes a system bus 1100, an application processor 1200, a main memory 1300, a modem 1400, a user interface 1500, and storage 1600.

The system bus 1100 provides connections to elements of the mobile apparatus 1000.

The application processor 1200 may be a main processor of the mobile apparatus 1000. The application processor 1200 may control the elements of the mobile apparatus 1000, execute operating system programs and application programs, and perform logical operations. The application processor 1200 may be a System-On-Chip (SOC).

The application processor 1200 includes an internal bus 1210, a core processor 1220, a digital signal processor (DSP) 1230, a direct memory access (DMA) 1240, a memory controller 1250, and an image processing device 1260.

The internal bus 1210 provides connections to the elements of the application processor 1200.

The core processor 1220 may control the elements of the application processor 1200 and perform various logical operations.

The DSP 1230 may perform predetermined high speed operations and assists the core processor 1220.

The DMA 1240 may access the main memory 1300 through the memory controller 1250 under control of the core processor 1220.

The memory controller 1250 provides an interface for the application processor 1200 to access the main memory 1300 or storage 1600.

The image processing device 1260 may perform operations with regard to image data and assist the core processor 1220. The image processing device 1260 includes a motion estimating unit (MEU) 1261, a motion compensating unit (MCU) 1263, and a pixel cache 1265.

The MEU 1261 may measure motion of a target object in an image based on image data of at least two consecutive images. The MEU 1261 may request image data necessary for motion measurement from the pixel cache 1265

The MCU 1263 may compensate an image based on the motion measured by the MEU 1261. For example, the MCU 1263 may use the measured motion to compensate for image noise, blurring, etc. The MCU 1263 may request image data from the pixel cache 1265 for motion compensation.

The pixel cache 1265 may fetch image data from the main memory 1300. If image data requested by the MEU 1261 or the MCU 1263 is stored in the pixel cache 1265, the pixel cache 1265 outputs the stored data. If image data requested by the MEU 1261 or the MCU 1263 is not stored in the pixel cache 1265, the pixel cache may fetch the requested data from the main memory 1300 and output the fetched data.

The pixel cache 1265 may be configured to fetch and output image data requested by elements of the applications processor 1200 other than the image processing device 1260. The location of the pixel cache 1265 is not limited to being part of the image processing device 1260 and may be provided as part of other elements of the application processor 1200 or separately from other elements of the application processor 1200.

The main memory 1300 may be an operation memory of the mobile apparatus 1000. The main memory 1300 may include at least one of a random access memory, such as a dynamic random access memory (DRAM), a static random access memory (SRAM), a phase-change random access memory (PRAM), a magnetoresistive random access memory (MRAM), a resistive random access memory (RRAM), a ferroelectric random access memory (FRAM), etc.

The modem 1400 may communicate with an external device through either wired or wireless channels. The modem 1400 may communicate with an external device using various communication techniques such as long-term evolution (LTE), code-division multiple access (CDMA), Global System for Mobile Communications (GSM), wireless fidelity (WiFi), Worldwide Interoperability for Microwave Access (WiMax), near-field communication (NFC), Bluetooth, radio-frequency identification (RFID), etc.

The user interface 1600 may exchange signals with a user. The user interface 1600 may include a user input interface, such as a camera, a microphone, a keyboard, a mouse, a touch pad, a touch panel, a touch screen, button, a switch, etc. The user interface 1600 may include a user output interface, such as a display device, a speaker, a lamp, a motor, etc. The display device may include a liquid crystal display (LCD), an active-matrix organic light-emitting diode (AMOLED) display, a beam projector, etc.

The storage 1600 may perform long-term storage of data in the mobile apparatus 1000. The storage 1600 may include at least one nonvolatile memory, such as a flash memory, an MRAM, a PRAM, an RRAM, an FRAM, a hard disc drive, etc.

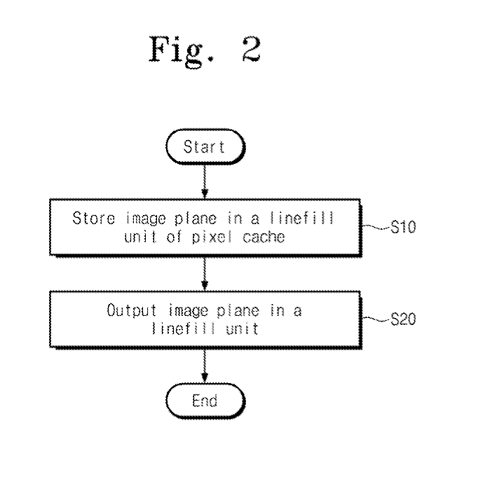

FIG. 2 is a flowchart of a method of operating a pixel cache in accordance with an embodiment of the inventive concept. Referring to FIGS. 1 and 2, at operation S10, an image plane is stored in a linefill unit of a pixel cache 1265.

At operation S20, the image plane stored in the linefill unit is outputted. The image plane may be outputted to the image processing device 1260 or to other elements of the application processor 1200.

The image plane may be part of the image stored in the main memory 1300. The image plane may be 2-dimensional (2D) data including at least two rows and at least two columns of pixels.

The linefill unit may be a data processing unit, in that data is stored in or outputted from the pixel cache 1265 at one time.

An image processing unit, such as the MEU 1261 or the MCU 1263, performs operations on the 2D image. According to an embodiment of the inventive concept, the pixel cache 1265 stores or outputs part of the image stored in the main memory 1300. The image part is 2D data including at least two rows and at least two columns of pixels. Data stored in the linefill unit of the pixel cache 1265 matches the 2D image used by the MEU 1261 or the MCU 1263 and thus, the number of pixel cache accesses may be reduced.

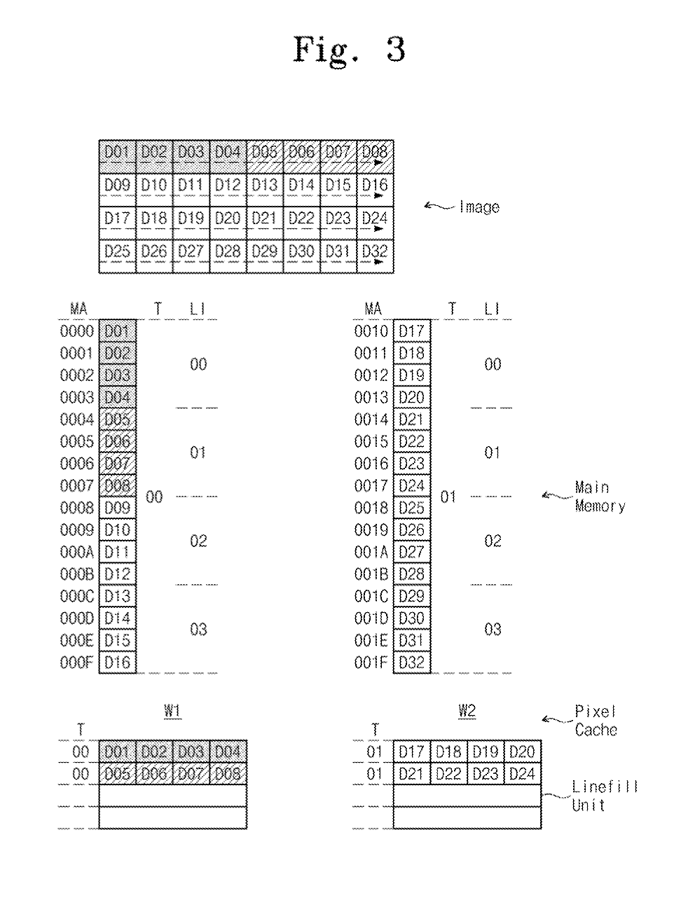

FIG. 3 illustrates an example where the pixel cache 1265 fetches image data stored in the main memory 1300. In FIGS. 1 and 3, there are provided the image, the main memory 1300 storing the image, and the pixel cache 1265 storing part of the image stored in the main memory 1300.

The image may include a plurality of pixels. The plurality of pixels may include corresponding data D01 to D32, respectively. One example of the image is shown in FIG. 3. The size of the image is not limited to any specific size.

Storage areas of the main memory 1300 are identified with memory addresses MA. The main memory 1300 may store pixel data in the storage areas, each having a corresponding memory address, that increase in the arrow direction shown in the image. In an embodiment, the storage areas of the main memory 1300 may store the first row data D01 to D08 of the image, which correspond to the memory address 0000 to the memory address 0007; the second row data D09 to D16 of the image, which correspond to the memory addresses 0008 to 000F; the third row data D17 to D24 of the image, which correspond to the memory addresses 0010 to 0017; and the fourth row data D25 to D32 of the image, which correspond to the memory addresses 0018 to 001F. The image stored in the main memory 1300 is linearly addressable.

The main memory 1300 may be divided into a plurality of groups. Each group may have storage areas having sequential addresses. Different tags T are assigned to the plurality of groups, respectively. For example, the storage areas having memory addresses 0000 to 000F form a group to which tag T00 is assigned. The storage areas having memory addresses 0010 to 001F form another group to which tag T01 is assigned. The number of the groups of the main memory 1300 is not limited to any specific number.

Each group of the main memory 1300 is divided to a plurality of sub-groups. Each sub-group may include storage areas having sequential addresses. Different line indexes LI are assigned to the sub-groups of each group, respectively. For example, in the group of the memory addresses 0000 to 000F, the line index 00 may be assigned to the sub-group of the memory addresses 0000 to 0003, the line index 01 may be assigned to the sub-group of the memory addresses 0004 to 0007, the line index 02 may be assigned to the sub-group of the memory addresses 0008 to 000B, and the line index 03 may be assigned to the sub-group of the memory addresses 000C to 000F. Further, in the group of the memory addresses 0010 to 001F, the line index 00 may be assigned to the sub-group of the memory addresses 0010 to 0013, the line index 01 may be assigned to the sub-group of the memory addresses 0014 to 0017, the line index 02 may be assigned to the sub-group of the memory addresses 0018 to 001B, and the line index 03 may be assigned to the sub-group of the memory addresses 001C to 001F. The number of the sub-groups of each group of the main memory 1300 is not limited to any specific number.

One line index LI may correspond to a data I/O unit of the pixel cache 1265. That is, the pixel cache 1265 may fetch at one time data from the main memory 1300 which has the same line index. Further, the pixel cache 1265 may output at one time data which has the same line index LI.

The pixel cache 1265 may include multiple frames W1 and W2. Each frame may correspond to each group of the main memory. Each frame includes a plurality of linefill units. The linefill units may respectively correspond to sub-groups of each group of the main memory 1300.

The image data stored in the main memory 1300 can be fetched to the pixel cache 1265 based on the tag T and the line index LI. In one embodiment, the pixel cache 1265 may refer to the line index LI of selected data to select a frame in which to store the selected data. The pixel cache 1265 may select a frame that has an empty linefill unit corresponding to the line index LI of the selected data. The selected data may be stored in the location corresponding to the line index LI of the selected data in the selected frame. In this case, the tag T of the selected data may be also stored in the pixel cache 1265.

In one embodiment, the tag 00 and the line index 00 may be assigned to the data D01 to D04 of the image. The data D01 to D04 may be stored in the cache location corresponding to the line index 00, i.e., the first linefill unit, of the frame W1. The tag 00 and the line index 01 may be assigned to the data D05 to D08 of the image. The data D05 to D08 may be stored in the second linefill unit of the frame W1.

The tag 01 and the line index 00 may be assigned to the data D17 to D20 of the image. The data D17 to D20 may be stored in the cache location corresponding to the line index 00, i.e., the first linefill unit, of the frame W2. The tag 01 and the line index 01 are assigned to the data D21 to D24 of the image. The data D21 to D24 may be stored in the second linefill unit of the frame W2.

In response to a request for image data, the pixel cache 1265 may extract the tag T and the line index LI from the address of the main memory 1300. If the data corresponding to the extracted tag T and line index LI has been stored, the pixel cache 1265 determines a “hit” and outputs the requested data. If data corresponding to the extracted tag T and line index LI has not been stored, the pixel cache 1265 determines a “miss” and fetches the requested data from the main memory 1300. The fetched data may be stored in the pixel cache 1265 and outputted according to the request.

As shown in FIG. 3, a linefill unit of the pixel cache 1265 may store data of a row or a partial row of an image.

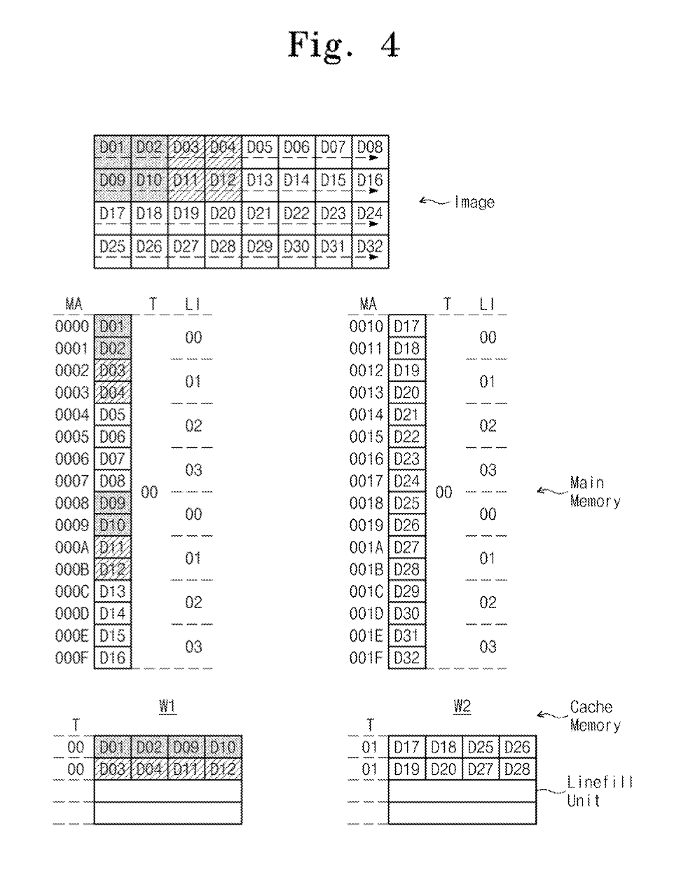

FIG. 4 illustrates a second example where the pixel cache 1265 fetches image data stored in the main memory 1300. In FIGS. 1 and 4, there are provided the image, the main memory 1300 storing the image, and the pixel cache 1265 storing part of the image stored in the main memory 1300.

Compared to FIG. 3, in FIG. 4, each sub-group of the main memory 1300 may include non-consecutive addresses. In one embodiment, in the group having the memory addresses 0000 to 000F, the line index 00 may be assigned to the sub-group having the memory addresses 0000, 0001, 0008, and 0009, the line index 01 may be assigned to the sub-group having the memory addresses 0002, 0003, 000A, and 000B, the line index 02 may be assigned to the sub-group having the memory addresses 0004, 0005, 000C, and 000D, and the line index 03 may be assigned to the sub-group having the memory addresses 0006, 0007, 000E, and 000F. Further, in the group having the memory addresses 0010 to 001F, the line index 00 may be assigned to the sub-group having the memory addresses 0010, 0011, 0018, and 0019, the line index 01 may be assigned to the sub-group having the memory addresses 0012, 0013, 001A, and 001B, the line index 02 may be assigned to the sub-group having the memory addresses 0014, 0015, 001C, and 001D, and the line index 03 may be assigned to the sub-group having the memory addresses 0016, 0017, 001E, and 001F.

The data D01, D02, D09, and D10 of the image has the tag 00 and the line index 00. The data D01, D02, D09, and D10 may be stored in the cache location corresponding to the line index 00, i.e., the first linefill unit, of the frame W1. The data D03, D04, D11, and D12 of the image has the tag 00 and the line index 01. The data D03, D04, D11, and D12 may be stored in the second linefill unit of the frame W1.

The data D17, D18, D25, and D26 of the image has the tag 01 and the line index 00. The data D17, D18, D25, and D26 may be stored in the cache location corresponding to the line index 00, i.e., the first linefill unit, of the frame W2. The data D19, D20, D27, and D28 of the image has the tag 01 and the line index 01. The data D19, D20, D27, and D28 may be stored in the second linefill unit of the frame W2.

As shown in FIG. 4, a single linefill unit of the pixel cache 1265 may store data including at least two rows and at least two columns of pixels. The 2D image stored in a single linefill unit of the pixel cache 1265 may define an image plane.

The image processing device 1260 can perform various calculations on the data stored in the pixel cache. The calculations of the image processing device 1260 may be spatially localized. For example, the calculations are performed in the image processing device 1260 on the 2D image. The image processing device 1260 can compare 2D areas with each other within a received image or among sequentially received images. As shown in FIG. 3, if the pixel cache 1265 stores image data of a row or a partial row, the image processing device 1260 needs to access the pixel cache 1265 several times to perform calculations. Accordingly, the pixel cache 1265 may access the main memory 1300 several times.

On the other hand, as shown in FIG. 4, if the pixel cache 1265 stores an image plane, the number of accesses to the pixel cache 1265 performed by the image processing device 1260 to perform calculations can be reduced. In particular, if the image plane stored in the pixel cache 1265 matches the 2D image required by the image processing device 1260, the image processing device 1260 can execute one pixel cache access to perform calculations. According to an embodiment of the inventive concept, the pixel cache 1265 can store an image plane in a single linefill unit. Thus, there is provided a pixel cache, method of operating a pixel cache, and an image processing device including a pixel cache, which can optimize data management of a spatially localized image.

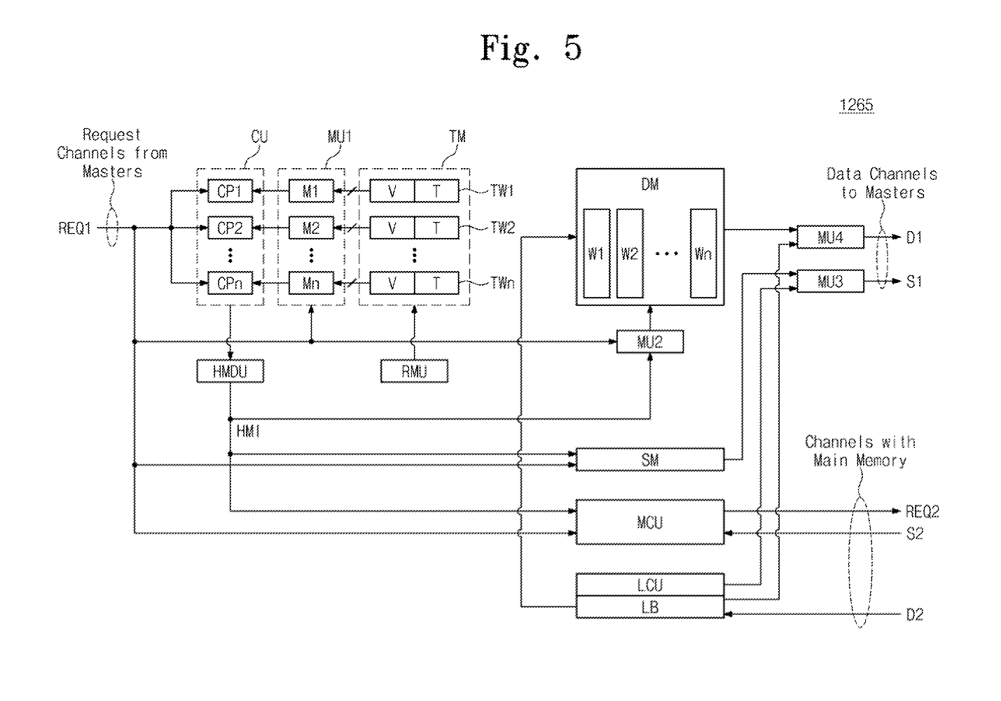

FIG. 5 is a block diagram of the pixel cache 1265 according to an embodiment of the inventive concept. Referring to FIGS. 1, 4, and 5, the pixel cache 1265 includes a data memory DM, a tag memory TM, multiplexer units MU1 to MU4, a comparison unit CU, a hit and miss determination unit HDMU, a replacement unit RMU, a state machine SM, a miss control unit MCU, a linefill control unit LCU, and a linefill buffer LB.

The pixel cache 1265 may receive a request REQ1 from a master. The master may be, for example, the image processing device 1260 or an external application processor. In response to the request REQ1, the pixel cache 1265 may output data D1 to the master. The pixel cache 1265 may output information indicating validity of the data D1 as signal S1, e.g., strobe signal indicating a valid signal section or clock of data D1.

In response to the request REQ1, the pixel cache 1265 may transmit a request REQ2 to the main memory 1300. The pixel cache 1265 may receive data D2 from the main memory 1300 and a signal S2 related to the data D2. The signal S2 may be information indicating validity of the data D2, e.g., strobe signal indicating a valid signal section or clock of data D2.

The data memory DM includes the multiple frames W1 to Wn. Each frame includes a plurality of linefill units. A single linefill unit may store a single image plane.

The tag memory TM includes a plurality of tag frames TW1 to TWn. The plurality of tag frames TW1 to TWn correspond to the multiple frames W1 to Wn, respectively. Each tag frame includes a plurality of tag lines. A single tag frame may store a tag T of the data stored in the corresponding linefill unit of the data memory DM. A single tag frame may further store validity information V indicating whether or not the data stored in the corresponding linefill unit of the data memory DM is valid.

The multiplexer unit MU1 includes a plurality of multiplexers M1 to Mn. The plurality of multiplexers M1 to Mn correspond to the plurality of tag frames TW1 to TWn, respectively. In response to the request REQ1 from the master, the multiplexer unit MU1 may select a tag line from the plurality of tag frames TW1 to TWn. In an embodiment, when the request REQ1 indicates a specific line index LI, each of the plurality of multiplexers M1 to Mn may select the requested line index LI from its corresponding tag frame. For example, if the request REQ1 indicates the line index 00, the multiplexers M1 to Mn may output the tags of the tag frames TW1 to TWn of the respective locations corresponding to the line index 00.

The comparison unit CU includes a plurality of comparators CP1 to CPn. The plurality of comparators CP1 to CPn correspond to the plurality of multiplexers M1 to Mn, respectively. The comparators CP1 to CPn may receive tags from the plurality of multiplexers M1 to Mn. The comparators CP1 to CPn may compare the tag T indicated by the request REQ1 with tags outputted from the multiplexers M1 to Mn.

The hit and miss determination unit HDMU may receive a comparison result from the comparison unit CU. Based on the comparison result, the hit and miss determination unit HDMU outputs the hit and miss information HMI. If it is determined that the tag indicated by the request REQ1 is stored in the tag memory TM, the hit and miss determination unit HDMU may output the hit and miss information HMI indicating a “hit.” If it is determined that the tag indicated by the request REQ1 is not stored in the tag memory TM, the hit and miss determination unit HDMU may output the hit and miss information HMI indicating a “miss.” That is, if the image plane corresponding to the request REQ1 is stored in the pixel cache 1265, the hit and miss determination unit HDMU may determine a “hit.” If the image plane corresponding to the request REQ1 is not stored in the pixel cache 1265, the hit and miss determination unit HDMU may determine a “miss.” The hit and miss information HMI may include information on the tag frame in which the “hit” occurs.

The replacement unit RMU may mange the tag memory TM. The replacement unit RMU may manage validity information V stored in the tag memory TM and the tag memory TM based on the validity information V. In an embodiment, the replacement unit RMU may delete a tag line that the validity information V indicates to be invalid. In another embodiment, the replacement unit RMU may delete the tag line that the validity information V indicates to be valid based on a least recently used (LRU) algorithm.

The multiplexer MU2 may operate based on the hit and miss information HMI. If the hit and miss information HMI indicates a “hit,” the multiplexer MU2 may transfer the line index LI included in the request REQ1 to the data memory DM. The multiplexer MU2 may transfer the frame information included in the hit and miss information HMI to the data memory DM. Based on the line index LI and frame information transferred from the multiplexer MU2, the image plane stored in the linefill unit of the data memory DM can be read out. The image plane read from the data memory DM can be outputted to the multiplexer MU4.

The state machine SM may control various operations of the pixel cache 1265. The state machine SM may control operations of the pixel cache 1265 based on the various signals such as the request REQ1 and the hit and miss information HMI. When an image plane read from the data memory DM is outputted, the state machine SM may output information indicating validity of the image plane read from the data memory DM. The validity information can be outputted to the multiplexer MU3.

The miss control unit MCU may operate based on the hit and miss information HMI. When the hit and miss information HMI indicates “miss,” the miss control unit MCU may transmit the request REQ1 to the main memory 1300 as request REQ2 according to the address included in the request REQ1. The miss control unit MCU may request the image plane requested by the request REQ1 from the main memory 1300. The miss control unit MCU may receive the signal S2 from the main memory 1300 and control the linefill control unit LCU or the linefill buffer LB based on the signal S2 to store the image plane.

The linefill control unit LCU may control the operations of the linefill buffer LB. The linefill control unit LCU may control the linefill buffer LB to store the image plane data D2 received from the main memory 1300. The linefill control unit LCU may control the linefill buffer LB to output the image plane stored in the linefill buffer LB to the data memory DM. The image plane transferred to the data memory DM may be stored in a single linefill unit of the data memory DM. In this case, the tag memory TM may be updated according to the tag T and the line index LI included in the request REQ1. In an embodiment, the tag T may be stored in the tag line corresponding to the linefill unit of the data memory DM storing the image plane.

The linefill control unit LCU may control the linefill buffer LB so that the image plane stored in the linefill buffer LB is outputted to the multiplexer MU4. The linefill control unit LCU may output the validity information to the multiplexer MU3 of the image plane outputted from the linefill buffer.

The multiplexer MU3 may receive the validity information from the state machine SM or the linefill control unit LCU. When a “hit” occurs, the multiplexer MU3 may select the validity information that is received from the state machine SM. When a “miss” occurs, the multiplexer MU3 may select the validity information that is received from the linefill control unit LCU. The multiplexer MU3 may output the selected information as the signal S1. Although it is not shown in FIG. 5 for the simplicity of an explanation, the multiplexer MU3 may operate in response to the hit and miss information HMI.

The multiplexer MU4 may receive the image plane from the data memory DM or the linefill buffer LB. When a “hit” occurs, the multiplexer MU4 may select the image plane that is received from the data memory DM. When a “miss” occurs, the multiplexer MU4 may select the image plane that is received from the linefill buffer LB. The multiplexer MU4 may output the selected image plane as the data D1. Although it is not shown in FIG. 5 for the simplicity of an explanation, the multiplexer MU4 may operate in response to the hit and miss information HMI.

The pixel cache 1265 stores an image plane in a single linefill unit. The image plane includes at least two rows and at least two columns of pixels. When the requested image plane is stored in the data memory DM, the pixel cache 1265 outputs the image plane stored in the data memory DM. When the requested image plane is not stored in the data memory DM, the pixel cache 1265 requests the image plane from the main memory 1300 and fetches the image plane. The pixel cache 1265 stores the fetched image plane in the data memory DM and outputs the fetched image plane. Storing and outputting the fetched image plane can be simultaneously performed.

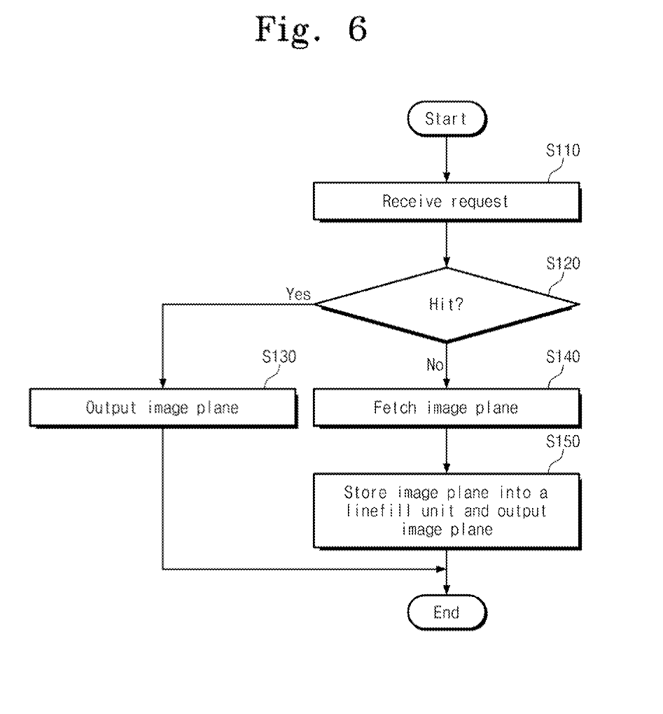

FIG. 6 is a flowchart of an example of a method of processing the pixel cache 1265 shown in FIG. 5. Referring to FIGS. 1, 4, 5 and 6, at operation S110, the request REQ1 is received. The request REQ1 may include information on the image plane such as an address. The tag T and the line index LI may be extracted from the received address.

At operation S120, it is determined whether or not a “hit” occurs. The hit and miss determination unit HMDU may determine that the requested image plane is stored in the data memory DM based on the tag T and the line index LI included in the request REQ1. If the requested image plane is stored, it is determined that a “hit” occurs. If the requested image plane is not stored, it is determined that a “miss” occurs.

If it is determined that a “hit” occurs, at operation S130, the requested image plane is outputted. If it is determined that a “miss” occurs, at operation S140, the requested image plane is fetched from the main memory 1300. At operation S150, the fetched image plane is stored in the linefill unit and outputted.

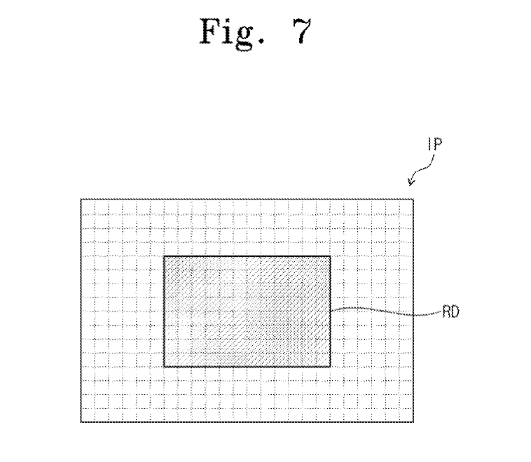

FIG. 7 illustrates examples of an image plane IP and requested data RD. As shown in FIG. 7, the requested data RD may be included in a single image plane IP. The pixel cache 1265 may receive the request for the image plane IP including the requested data and output the image plane IP. The pixel cache 1265 may receive the request for the requested data RD and output the image plain IP. The pixel cache 1265 may receive the request for the requested data RD and output the corresponding part to the requested data RD from the image plane IP.

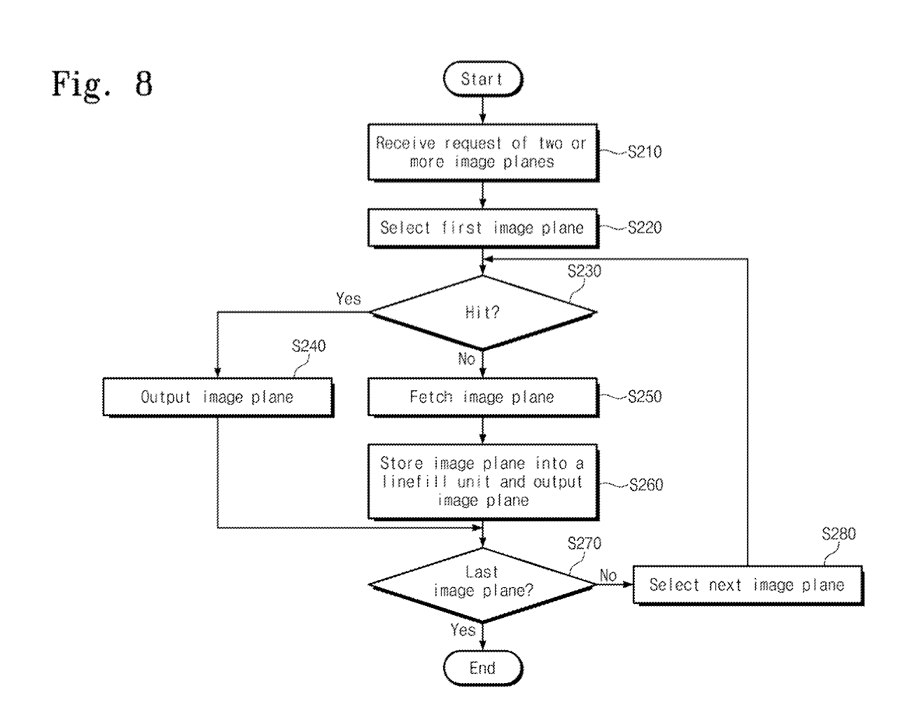

FIG. 8 is a flowchart of another example of a method of operating the pixel cache 1265 shown in FIG. 5. Referring to FIGS. 1, 4, 5, and 8, at operation S210, the request REQ1 is received. The request REQ1 may include the information on two or more image planes such as an address. The tag T and the line indexes LI may be extracted from the received addresses.

At operation S220, the first image plane is selected. At operation S230, it is determined whether or not a “hit” occurs. If a “hit” occurs, the requested image plane is outputted at operation S240.

If a “hit” does not occur, the requested image plane is fetched from the main memory 1300 at operation S250. At operation S260, the fetched image plane is stored in the data memory DM and the fetched image plane is outputted.

At operation S270, it is determined whether or not the outputted image plane is the last image plane. If the outputted image plane is the last image plane, the process ends. If the outputted image plane is not the last image plane, at operation S280, the next image plane is selected and the process returns to operation S230.

Referring to FIG. 8, according to an embodiment of the inventive concept, the pixel cache 1265 storing the image plane in the linefill unit may receive a request for two or more image planes at one time and sequentially output the two or more image planes according to the received request.

FIG. 9 illustrates an example of how the pixel cache 1265 receives a request for two or more image planes. Referring to FIGS. 5 and 9, an image is provided, which includes the image planes IPs arranged through rows 1 to 4 and columns a to h. The requested data RD corresponds to the image planes arranged through rows 1 and 3 to columns b to e.

The request REQ1 to the pixel cache 1265 may include information on the address of the reference point RP of the requested data RD and the width OFF_X of the requested data RD. The reference point RP may correspond to the position of the lowest address of the requested data RD addresses. The reference point RP may be the upper left position of the requested data RD.

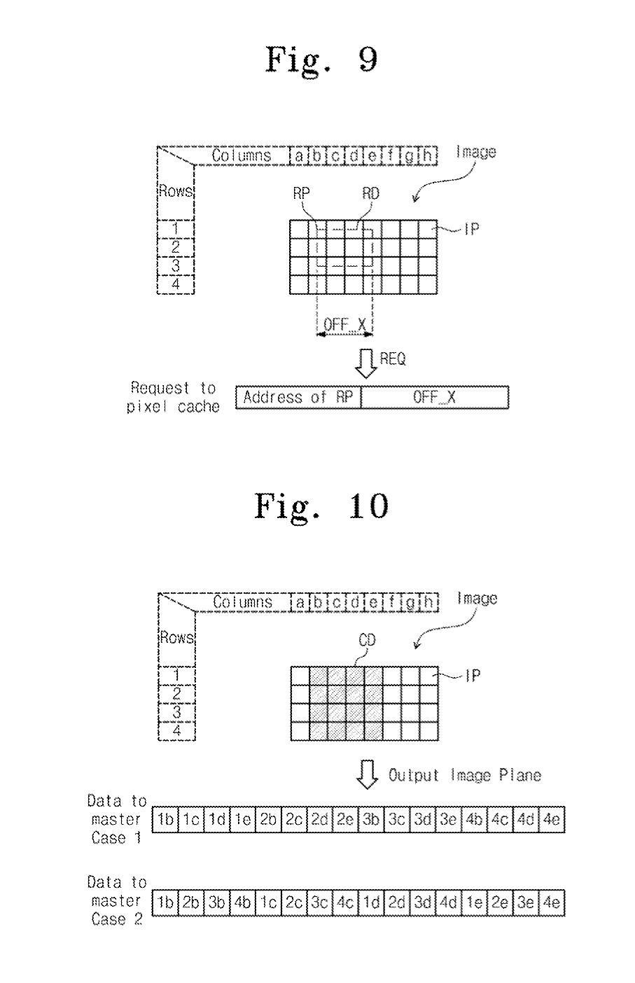

FIG. 10 illustrates an example of how the pixel cache 1265 outputs the requested data RD in response to the request in FIG. 9. Referring to FIGS. 5, 9, and 10, the pixel cache 1265 may output the requested data RD in at least two different ways.

In an example of the inventive concept, the pixel cache 1265 may output the image planes based on rows of the image planes. The pixel cache 1265 may output the first image planes in a single row and then output subsequent image planes in subsequent rows. In an embodiment, the pixel cache 1265 may sequentially output the image planes IP_{—}1b to IP_{—}1e in the first row, the image planes IP_{—}2b to IP_{—}2e in the second row, the image planes IP_{—}3b to IP_{—}3e in the third row, and the image planes IP_{—}4b to IP_{—}4e in the fourth row.

In another example of the inventive concept, the pixel cache 1265 may output the image planes based on columns of the image planes. The pixel cache 1265 may output the first image planes in the single column and then output subsequent image planes in subsequent columns. For example, the pixel cache 1265 may sequentially output the image planes IP_{—}1b to IP_{—}4b in the first column, the image planes IP_{—}1c to IP_{—}4c in the second column, the image planes IP_{—}1d to IP_{—}4d in the third column, and the image planes P_{—}1e to IP_{—}4e in the fourth column.

If the request REQ1 includes the address of the reference point RP and the width OFF_X, the data CD to be outputted from the pixel cache 1265 may include not only the requested data RD but also the image planes not included in the requested data RD. The master transmitting the request REQ1, e.g., the image processing device 1260 or other elements of the application processor 1200 shown in FIG. 1, may select only the part corresponding to the requested data RD from the image planes IPs received from the pixel cache 1265 on which to perform calculations.

In another embodiment of the inventive concept, in response to the request REQ1, the pixel cache 1265 may output only data corresponding to the requested data RD. For example, among the image planes 1b to 1e in the first row, only the part corresponding to the requested data RD may be outputted instead of the entire data. Likewise, among the image planes 4b to 4e in the fourth row, among the image planes 1b to 4b in the first column, and among the image planes 1e to 4e in the fourth column, only the part corresponding to the requested data RD may be outputted instead of the entire data.

The master processing the image may request a 2D image based on a spatial location. While using the pixel cache 1265 according to an embodiment of the inventive concept, a plurality of image planes corresponding to a plurality of linefill units of the pixel cache 1265 can be requested through a single request REQ1. Thus, the number of pixel cache 1265 accesses can be reduced and the performance of the image processing device 1260 or the application processor 1200, both including the pixel cache 1265, can be enhanced.

An embodiment of requesting as explained with regard to FIGS. 9 and 10 is not limited to requesting a plurality of image planes. For example, as explained with regard to FIG. 7, if the requested data RD is included within a single image plane, the request REQ1 may include the address of the reference point RP and the width OFF_X. An embodiment of requesting as explained with regard to FIGS. 9 and 10 may be applied regardless of the size of the requested data RD. Thus, even if the size of the requested data RD that is required by the master varies, the request can be still transmitted in the same way.

FIG. 11 illustrates another example of how the pixel cache 1265 receives a request for two or more image planes. Referring to FIGS. 5 and 11, an image is provided, which includes the image planes IPs arranged in rows 1 to 4 and columns a to h. The requested data RD corresponds to the image planes arranged in rows 1 to 3 and columns b to e.

Unlike the embodiment shown in FIG. 9, in the embodiment shown in FIG. 11, the request REQ1 may include the information on the address of the image plane IP_{—}1b including the reference point RP and the width OFF_X. The width OFF_X may include the width of the image planes including the requested data RD.

The address of the image plane IP_{—}1b including the reference point RP may be the lowest address of the image plane IP_{—}1b addresses. The address of the image plane IP_{—}1b including the reference point RP may be the upper left position of the image plane IP_{—}1b including the reference point RP.

If the request REQ1 is transmitted according to an embodiment shown in FIG. 11, the pixel cache 1265 may output the image planes according to an embodiment shown in FIG. 10.

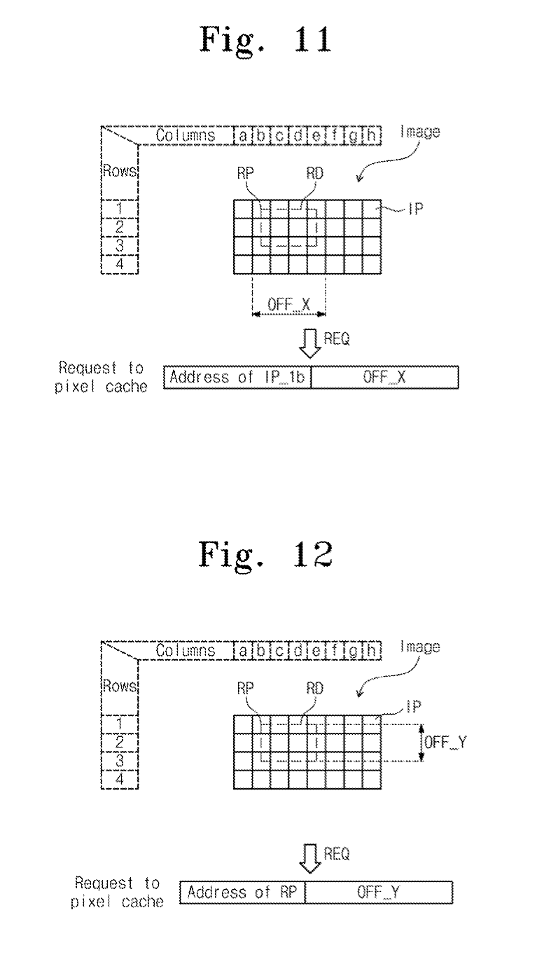

FIG. 12 illustrates another example of how the pixel cache 1265 receives a request for two or more image planes. Referring to FIGS. 5 and 12, an image is provided, which includes the image planes IPs arranged in rows 1 to 4 and columns a to h. The requested data RD corresponds to the image planes arranged in rows 1 to 3 and columns b to e.

The request REQ1 to the pixel cache 1265 may include information on the address of the reference point RP of the requested data RD and the vertical length OFF_Y of the requested data RD. The reference point RP may correspond to the position of the lowest address of the requested data RD addresses. The reference point RP may be the upper left position of the requested data RD.

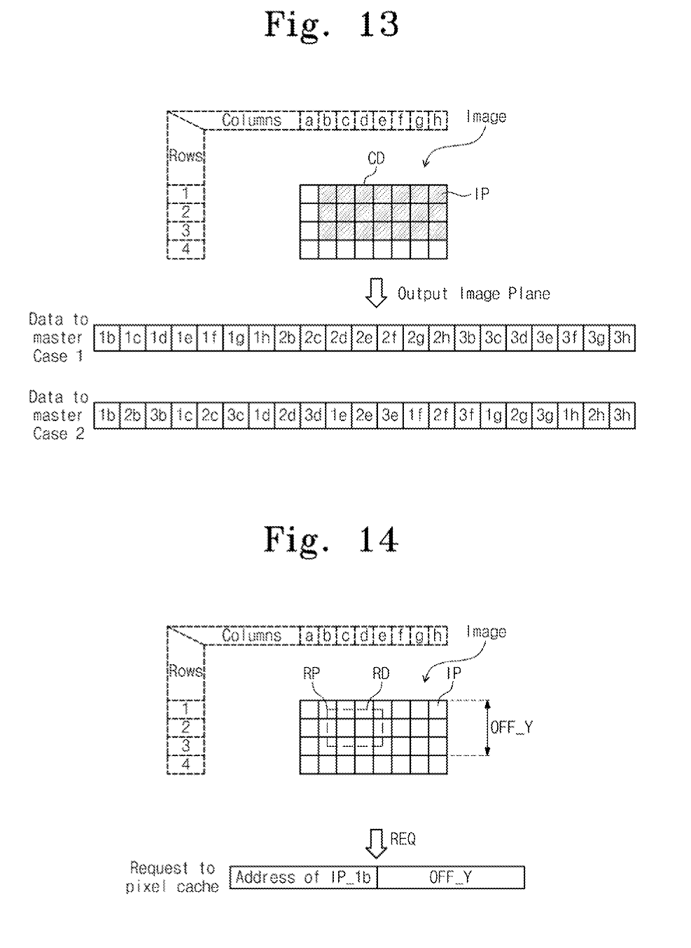

FIG. 13 illustrates an example of how the pixel cache 1265 outputs the requested data RD in response to the request in FIG. 12. Referring to FIGS. 5, 12, and 13, the pixel cache 1265 may output the requested data RD in at least two different ways.

In an example of the inventive concept, the pixel cache 1265 may output the image planes based on rows. The pixel cache 1265 may output the first image planes in a single row and then output subsequent image planes in subsequent rows. For example, the pixel cache 1265 may sequentially output the image planes 1b to 1h in the first row, the image planes 2b to 2h in the second row, the image planes 3b to 3h in the third row, and the image planes 4b to 4h in the fourth row.

In another example of the inventive concept, the pixel cache 1265 may output the image planes based on columns. The pixel cache 1265 may output the first image planes in a single column and then output subsequent image planes in subsequent columns. For example, the pixel cache 1265 may sequentially output the image planes 1b to 3b in the first column, the image planes 1c to 3c in the second column, the image planes 1d to 3d in the third column, the image planes 1e to 3e in the fourth column, the image planes 1f to 3f in the fifth column, the image planes 1g to 3g in the sixth column, and the image planes 1h to 3h in the seventh column.

If the request REQ1 includes the address of the reference point RP and the vertical length OFF_Y, the data CD to be outputted from the pixel cache 1265 may include not only the requested data RD but also image planes not included in the requested data RD. The master transmitting the request REQ1, e.g., the image processing device 1260 or other elements of the application processor 1200 shown in FIG. 1, may select only the part corresponding to the requested data RD from the image planes IPs received from the pixel cache 1265 on which to perform calculations.

In another example of the inventive concept, in response to the request REQ1, the pixel cache 1265 may output only data corresponding to the requested data RD. For example, among the image planes 1b to 1h in the first row, only the part corresponding to the requested data RD may be outputted instead of the entire data. Likewise, among the image planes 3b to 3h in the third row, among the image planes 1b to 3b in the first column, and among the image planes 1h to 3h in the seventh column, only the part corresponding to the requested data RD may be outputted instead of the entire data.

The master processing the image may request a 2D image based on a spatial location. While using the pixel cache 1265 according to an embodiment of the inventive concept, a plurality of image planes corresponding to a plurality of linefill units of the pixel cache 1265 can be requested through a single request REQ1. Thus, the number of pixel cache 1265 accesses can be reduced and the performance of the image processing device 1260 or the application processor 1200, both including the pixel cache 1265, can be enhanced.

An embodiment of requesting as explained with regard to FIGS. 12 and 13 is not limited to requesting a plurality of image planes. For example, as already explained with regard to FIG. 7, if the requested data RD is included within the single image plane, the request REQ1 may include the address of the reference point RP and the vertical length OFF_Y. An embodiment of requesting as explained with regard to FIGS. 12 and 13 may be applied regardless of the size of the requested data RD. Thus, if the size of the requested data RD required by the master varies, the request can be still transmitted in the same way.

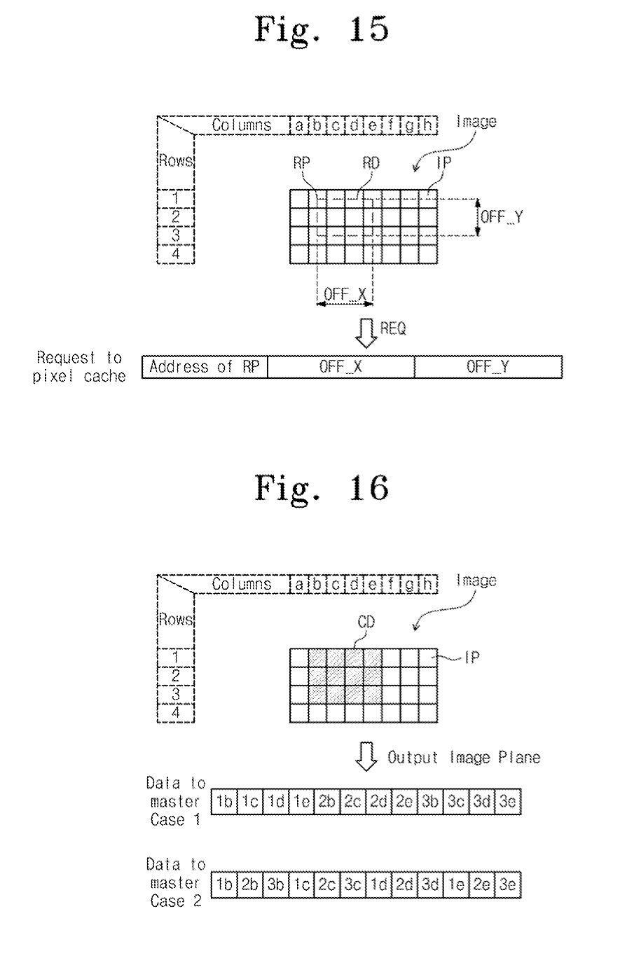

FIG. 14 illustrates another example on how the pixel cache 1265 receives a request for two or more image planes. Referring to FIGS. 5 and 14, an image is provided, which includes image planes IPs arranged in rows 1 to 4 and columns a to h. The requested data RD corresponds to the image planes arranged in rows 1 to 3 and columns b to e.

According to an embodiment of the inventive concept, in FIG. 14, the request REQ1 may include information on the address of the image plane IP_{—}1b including the reference point RP and the vertical length OFF_Y. The vertical length OFF_Y may include the vertical length of the image planes in which the requested data RD is included.

The address of the image plane IP_{—}1b including the reference point RP may be the lowest address of the image plane IP_{—}1b addresses. The address of the image plane IP_{—}1b including the reference point RP may be the upper left position of the image plane IP_{—}1b including the reference point RP.

If the request REQ1 is transmitted according to an embodiment shown in FIG. 14, the pixel cache 1265 may output the image planes according to an embodiment shown in FIG. 13.

FIG. 15 illustrates another example on how the pixel cache 1265 receives a request for two or more image planes. Referring to FIGS. 5 and 15, an image is provided, which includes image planes IPs arranged in rows 1 to 4 and columns a to h. The requested data RD corresponds to the image planes in rows 1 to 3 and columns b to e.

The request REQ1 to the pixel cache 1265 may include information on the address of the reference point RP of the requested data RD, the horizontal width OFF_X of the requested data RD from the reference point RP, and the vertical length OFF_Y of the requested data RD from the reference point RP. The reference point RP may correspond to the position of the lowest address of the requested data RD addresses. The reference point RP may be the upper left position of the requested data RD.

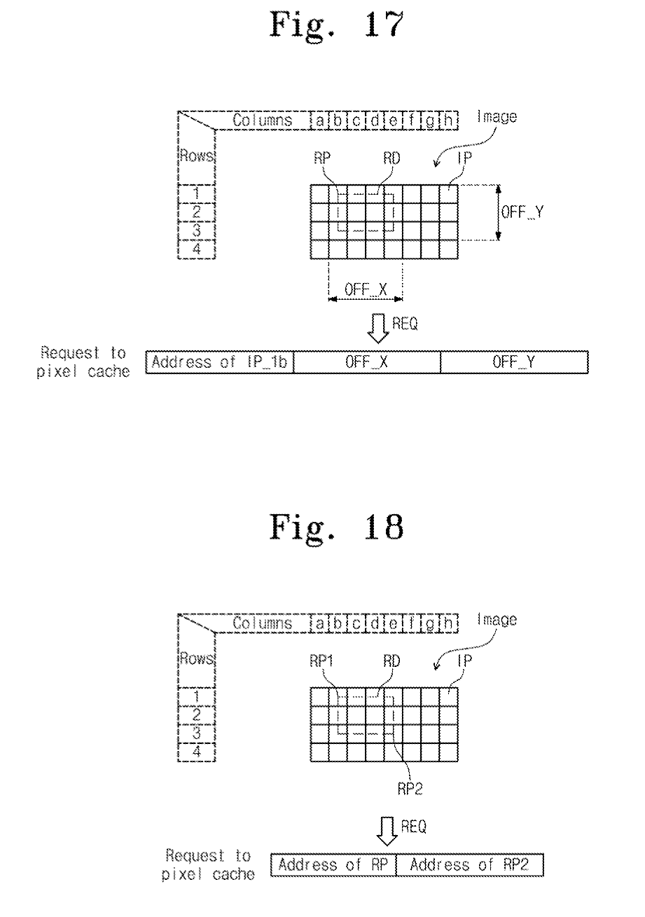

FIG. 16 illustrates an example of how the pixel cache 1265 outputs the requested data RD in response to the request in FIG. 15. Referring to FIGS. 5, 15, and 16, the pixel cache 1265 may output the requested data RD in at least two different ways.

In an example of the inventive concept, the pixel cache 1265 may output the image planes based on rows of image planes. The pixel cache 1265 may output the first image planes in a first row and then output subsequent image planes in subsequent rows. For example, the pixel cache 1265 may sequentially output image planes 1b to 1d in the first row, image planes 2b to 2d in the second row, and image planes 3b to 3d in the third row.

In another example of the inventive concept, the pixel cache 1265 may output the image planes based on columns of image planes. The pixel cache 1265 may output the first image planes in a first column and then output subsequent image planes in subsequent columns. For example, the pixel cache 1265 may sequentially output image planes 1b to 3b in the first column, image planes c to 3c in the second column, and image planes 1d to 3d in the third column.

If the request REQ1 includes the address of the reference point RP, the horizontal width OFF_X, and the vertical length OFF_Y, the data CD that is to be outputted from the pixel cache 1265 may include the image planes corresponding to the requested data RD. The master transmitting the request REQ1, e.g., the image processing device 1260 or other elements of the application processor 1200 shown in FIG. 1, may select only the part corresponding to the requested data RD from the image planes IPs received from the pixel cache 1265 on which to perform calculations.

In another example of the inventive concept, in response to the request REQ1, the pixel cache 1265 may output only data corresponding to the requested data RD. For example, among the image planes 1b to 1d in the first row, only the part corresponding to the requested data RD can be outputted instead of the entire data. Likewise, among the image planes 3b to 3c in the third row, among the image planes 1b to 3b in the first column, and among the image planes 1e to 3e in the fourth column, only the part corresponding to the requested data RD can be outputted instead of the entire data.

The master processing the image may request a 2D image based on a spatial location. While using the pixel cache 1265 according to an embodiment of the inventive concept, a plurality of image planes corresponding to a plurality of linefill units of the pixel cache 1265 can be requested through a single request REQ1. Thus, the number of pixel cache 1265 accesses can be reduced and the performance of the image processing device 1260 or the application processor 1200, both including the pixel cache 1265, can be enhanced.

An embodiment of requesting as explained with regard to FIGS. 15 and 16 is not limited to requesting a plurality of image planes. For example, as already explained with regard to FIG. 7, even if the requested data RD is included within a single image plane, the request REQ1 may include the address of the reference point RP, the horizontal width OFF_X, and the vertical length OFF_Y. An embodiment of requesting as explained with regard to FIGS. 15 and 16 may be applied regardless of the size of the requested data RD. Thus, even if the size of the requested data RD varies, the request can be still transmitted in the same way.

FIG. 17 illustrates another example of how the pixel cache 1265 receives a request for two or more image planes. Referring to FIGS. 5 and 17, an image is provided, which includes image planes IPs arranged in rows 1 to 4 and columns a to h. The requested data RD corresponds to the image planes in rows 1 to 3 and columns b to e.

According to an embodiment of the inventive concept, in FIG. 17, the request REQ1 may include information on the address of the image plane IP_{—}1b including the reference point RP, the horizontal length OFF_X, and the vertical length OFF_Y. The horizontal length OFF_X may include the length of the image planes including the requested data RD. The vertical length OFF_Y may include the vertical length of the image planes including the requested data RD.

The address of the image plane IP_{—}1b including the reference point RP may be the lowest address of the image plane IP_{—}1b addresses. The address of the image plane IP_{—}1b including the reference point RP may be the upper left position of the image plane IP_{—}1b including the reference point RP.

If the request REQ1 is transmitted according to an embodiment shown in FIG. 17, the pixel cache 1265 may output the image planes according to the embodiment shown in FIG. 15.

FIG. 18 illustrates another example of how the pixel cache 1265 receives a request for two or more image planes. Referring to FIGS. 5 and 18, an image is provided, which includes image planes IPs arranged in rows 1 to 4 and columns a to h. The requested data RD corresponds to the image planes in rows 1 to 3 and columns b to e.

The request REQ1 to the pixel cache 1265 may include information on the address of a first reference point RP1 of the requested data RD, and the address of a second reference point RP2. The first reference point RP1 may correspond to the position of the lowest address of the requested data RD addresses. The first reference point RP1 may be the upper left position of the requested data RD. The second reference point RP2 may correspond to the position of the highest address of the requested data RD addresses. The second reference point RP2 may be the lower right position of the requested data RD.

If the request REQ1 is transmitted according to an embodiment shown in FIG. 18, the pixel cache 1265 may output the image planes according to an embodiment shown in FIG. 15.

If the request REQ1 includes the address of the first reference point RP1 and the address of the second reference point RP2, the data CD that is to be outputted from the pixel cache 1265 may include image planes corresponding to the requested data RD. The master transmitting the request REQ1, e.g., the image processing device 1260 or other elements of the application processor 1200 shown in FIG. 1, may select only the part corresponding to the requested data RD from the image planes IPs received from the pixel cache 1265 on which to perform calculations.

In another example of the inventive concept, in response to the request REQ1, the pixel cache 1265 may output only the data corresponding to the requested data RD. For example, among the image planes 1b to 1d in the first row, only the part corresponding to the requested data RD may be outputted instead of the entire data. Likewise, among the image planes 3b to 3c in the third row, among the image planes 1b to 3b in the first column, and among the image planes 1e to 3e in the fourth column, the only part corresponding to the requested data RD may be outputted instead of the entire data.

The master processing the image may request a 2D image based on a spatial location. While using the pixel cache 1265 according to an embodiment of the inventive concept, a plurality of image planes corresponding to a plurality of linefill units of the pixel cache 1265 can be requested through a single request REQ1. Thus, the number of pixel cache 1265 accesses can be reduced and the performance of the image processing device 1260 or the application processor 1200, both including the pixel cache 1265, can be enhanced.

An embodiment of requesting as explained with regard to FIG. 18 is not limited to requesting a plurality of image planes. For example, as already explained with regard to FIG. 7, if the requested data RD is included within one image plane, the request REQ1 may include the address of the first reference point RP1 and the address of the second reference point RP2. An embodiment of requesting as explained with regard to FIG. 18 may be applied regardless of the size of the requested data RD. Thus, if the size of the requested data RD varies, the request can be still transmitted in the same way.

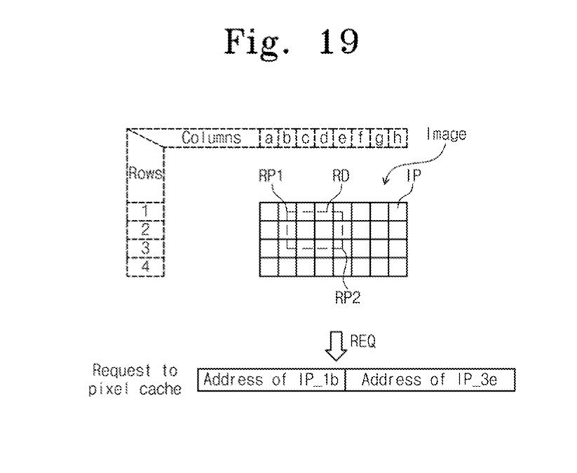

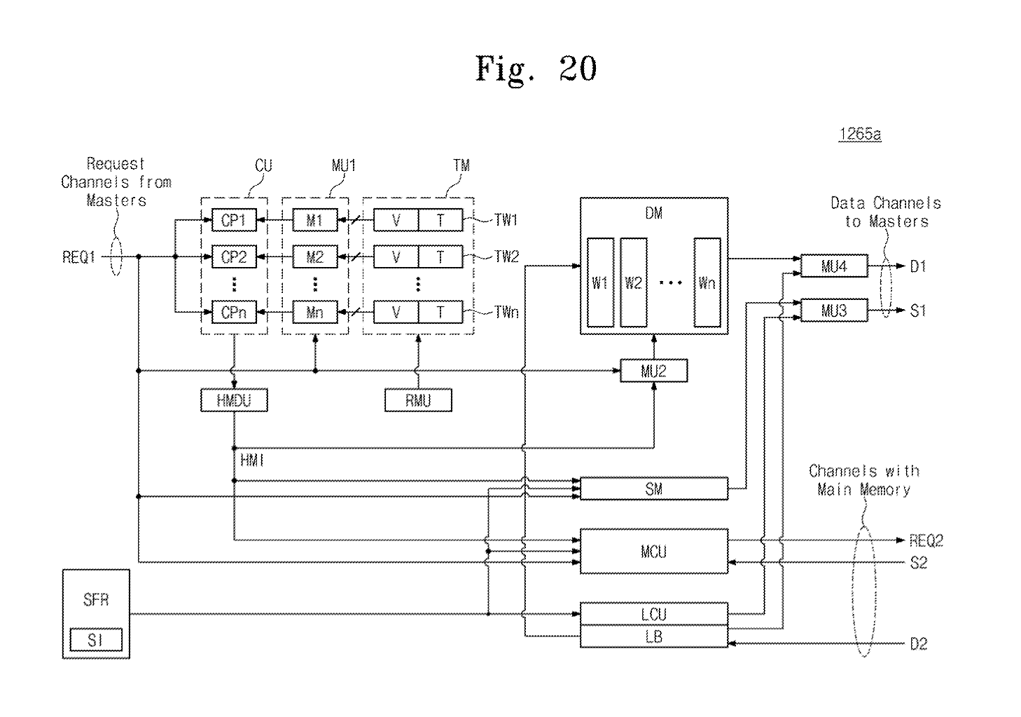

FIG. 19 illustrates another example of how the pixel cache 1265 receives the request for two or more image planes. Referring to FIGS. 5 and 19, an image is provided, which includes image planes IPs arranged in rows 1 to 4 and columns a to h. The requested data RD corresponds to the image planes in rows 1 to 3 and columns b to e.

According to an embodiment of the inventive concept, in FIG. 19, the request REQ1 may include information on the address of the image plane IP_{—}1b including the first reference point RP1 and the address of the image plane IP_{—}3e including the second reference point RP2. The address of the image plane IP_{—}1b including the first reference point RP1 may be the lowest address of the image plane IP_{—}1b addresses. The address of the image plane IP_{—}1b including the first reference point RP1 may be the upper left position of the image plane IP_{—}1b including the first reference point RP1. The address of the image plane IP_{—}3e including the second reference point RP2 falls may be the lowest address of the image plane IP_{—}3e addresses. The address of the image plane IP_{—}3e including the second reference point RP2 may be the upper left position of the image plane IP_{—}3e including the second reference point RP2.

If the request REQ1 is transmitted according to an embodiment shown in FIG. 19, the pixel cache 1265 may output the image planes according to an embodiment shown in FIG. 15.

Embodiments of the request received by the pixel cache 1265 have been explained with regard to FIGS. 9 to 19. The pixel cache 1265 may receive a request from the master according to any one of the embodiments as explained in FIGS. 9 to 19. The master of the pixel cache j1265, e.g., at least one of the image processing device 1260 or other elements of the application processor 1200, may transmit a request to the pixel cache 1265 according to an embodiment as explained with regard to FIGS. 9 to 19. In another embodiment of the inventive concept, a transform unit may be provided in the application processor 1200, the image processing device 1260, or the pixel cache 1265. The transform unit may transform the request from the master to the pixel cache 1265 so that the request corresponds to an embodiment as explained with regard to FIGS. 9 to 19

FIG. 20 is a block diagram of a pixel cache 1265a according to another embodiment of the inventive concept. Referring to FIGS. 1, 4, and 20, the pixel cache 1265a includes a data memory DM, a tag memory TM, multiplexer units MU1 to MU4, a comparison unit CU, a hit and miss determination unit HDMU, a replacement unit RMU, a state machine SM, a miss control unit MCU, a linefill control unit LCU, a linefill buffer LB, and a special function register SFR. Compared to an embodiment of the pixel cache 1265 shown in FIG. 5, the pixel cache 1265a further includes the special function register SFR.

The special function register SFR may store various information used by the operations of the pixel cache 1265a. The special function register SFR may be set by an external device or by a user of the pixel cache 1265a. The special function register SFR may store size information SI.

The size information SI may be information on the size of the linefill unit of the pixel cache 1265a. The pixel cache 1265a may control the size of the linefill unit so that the size of the linefill unit may correspond to the size information SI.

For example, the state machine SM may receive the size information SI from the special function register SFR and control the pixel cache 1265a based on the received size information SI. The state machine SM may control the data memory DM to store image plane data having a size corresponding to the size information SI. The state machine SM may control the tag memory TM to store tag information of an image plane having a size corresponding to the size information SI. The state machine SM may control elements of the pixel cache 1265a to fetch and output image planes having size corresponding to the size information SI.

The miss control unit MCU may request from main memory an image plane having a size corresponding to the size information SI.

The linefill control unit LCU may control the linefill buffer LB to store an image plane having a size corresponding to the size information SI.

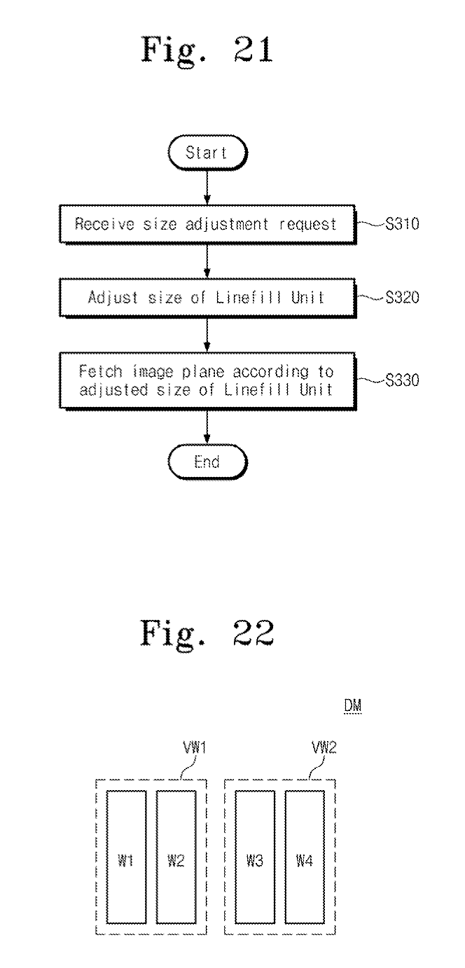

FIG. 21 is a flowchart illustrating a method of operating the pixel cache 1265a shown in FIG. 20. Referring to FIGS. 20 and 21, at operation S310, a request for adjusting the size is received. For example, the pixel cache 1265a may recognize that the size information SI is stored in the special function register SFR. In an embodiment, when power is supplied to a system-on-chip or mobile apparatus including the pixel cache 1265a, the master apparatus accessing the pixel cache 1265a may transfer the size information SI to the pixel cache 1265a. The master apparatus may transfer the size of an image plane as the size information SI.

At operation S320, the size of the linefill unit is adjusted. The pixel cache 1265a may adjust the size of the linefill unit based on the size information SI stored in the special function register SFR.

At operation S330, data is fetched based on the adjusted size of the linefill unit. The pixel cache 1265a may fetch data from the main memory 1300 based on the adjusted size of the linefill unit. The pixel cache 1265a may output the fetched data.

FIG. 22 shows an example where data memory is managed together with control of the linefill unit size. In an embodiment of the inventive concept, in FIG. 22, the size of the linefill unit increases twice. Referring FIGS. 20 and 22, a single virtual frame is formed by grouping at least two frames of the data memory DM. In one embodiment, the frames W1 and W2 form a virtual frame VW1, and the frames W3 and W4 form another virtual frame VW2. The single linefill unit of the frame W1 and the single linefill unit of the frame W2, both W1 and W2 forming the virtual frame VW1, may be treated as a single combined linefill unit.

While FIG. 22 shows only one example of varying the size of the linefill unit, the size of the linefill unit may vary in other ways. For example, the respective linefill units of each frame may be divided and treated as at least two divided linefill units.

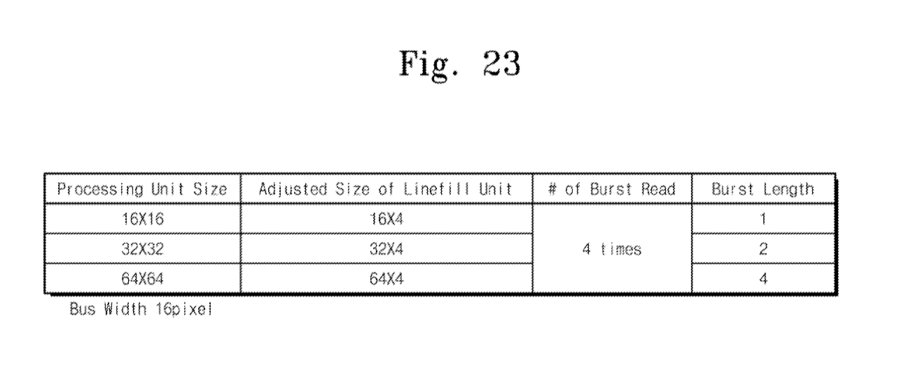

FIG. 23 shows a table describing the processing unit size of the master apparatus and the size of the linefill unit. Referring to FIG. 23, when the processing unit size of the master apparatus accessing the pixel cache 1265a is 16×16, the size of the linefill unit of the pixel cache 1265a may be 16×4. In this case, the master apparatus transmits the access request to the pixel cache 1265a four times to perform one calculation. The burst length may be the size of 1 linefill unit.

If the processing unit size of the master apparatus is 32×32, the size of the linefill unit of the pixel cache 1265a may be adjusted to 32×4. In this case, the master apparatus transmits the access request to the pixel cache 1265a four times to perform one calculation. The burst length may be the size of 1 linefill unit.

If the processing unit size of the master apparatus is 64×64, the size of the linefill unit of the pixel cache 1265a may be adjusted to 64×4. In this case, the master apparatus transmits the access request to the pixel cache 1265a four times to perform one calculation. The burst length may be the size of 1 linefill unit.

As described above, even if the processing unit size of the master apparatus changes, since the size of the linefill unit of the pixel cache 1265a varies in accordance with the processing unit size of the master apparatus, the number of master apparatus accesses to the pixel cache 1265 does not increase. Thus, the performance of a mobile apparatus including the pixel cache 1265a can be enhanced.

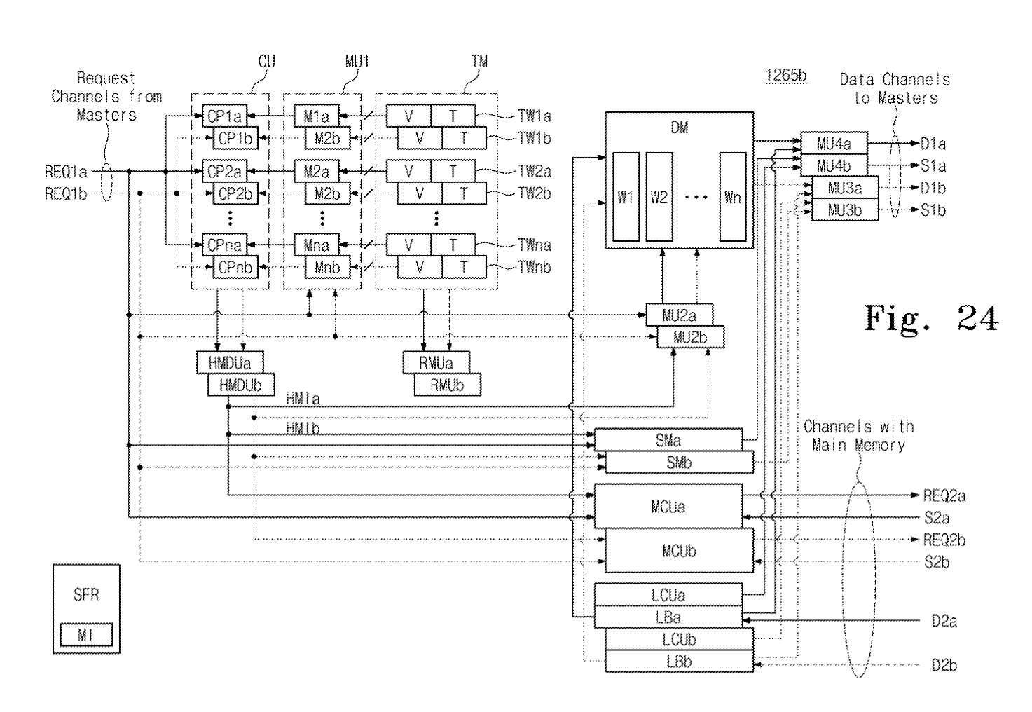

FIG. 24 is a block diagram of a pixel cache 1265b according to a third embodiment of the inventive concept. The pixel cache 1265b includes a data memory DM, a tag memory TM, multiplexer units MU1 to MU4, a comparison unit CU, a hit and miss determination unit HDMU, a replacement unit RMU, a state machine SM, a miss control unit MCU, a linefill control unit LCU, a linefill buffer LB, and a special function register SFR. Compared to the pixel cache 1265 shown in FIG. 5, the pixel cache 1265a further includes the special function register SFR.

The special function register SFR may store various information used by the operations of the pixel cache 1265b. The special function register SFR may be set by an external device or by a user of the pixel cache 1265b. The special function register SFR may store multiple information MI.

The multiple information MI may be the number of the image planes that can be simultaneously processed by the pixel cache 1265b. The multiple information MI may be the number of the requests REQ that can be simultaneously processed by the pixel cache 1265b. FIG. 24 shows the pixel cache 1265b capable of simultaneously processing the two requests REQ1 and REQ2 according to an embodiment of the inventive concept.

The respective elements of the pixel cache 1265b may be partitioned to separately process the first request REQ1 and the second request REQ2. In one embodiment, tag frames TW1a to TWna of the tag memory TM, multiplexers M1a to Mna of the multiplexer unit MU1, comparators CP1a to CPna of the comparison unit CU, the hit and miss determination unit HMDUa, the replacement unit RMUa, the multiplexer unit MU2a, the multiplexer unit MU3a, the multiplexer unit MU4a, the state machine SMa, the miss control unit MCUa, the linefill control unit, LCUa, and the linefill buffer LBa can operate in response to the first request REQ1. These elements may generate the hit and miss signal MHIa in response to the first request REQ1, transfer the request REQ2a to the main memory 1300, receive data D2a and the signal S2a from the main memory 1300, and output data D1a and the signal S1a.

In addition, tag frames TW1b to TWnb of the tag memory TM, multiplexers M1b to Mnb of the multiplexer unit MU1, comparators CP1b to CPnb of the comparison unit CU, the hit and miss determination unit HMDUb, the replacement unit RMUb, the multiplexer unit MU2b, the multiplexer unit MU3b, the multiplexer unit MU4b, the state machine SMb, the miss control unit MCUb, the linefill control unit, LCUb, and the linefill buffer LBb may operate in response to the second request REQ2. These elements may generate the hit and miss signal MHIb in response to the second request REQ2, transfer the request REQ2b to the main memory 1300, receive data D2b and the signal S2b from the main memory 1300, and output data D1b and the signal S1b.

The data memory DM may be partitioned into a plurality of groups based on the multiple information MI. Each group may store the image planes corresponding to one request. In one embodiment, as shown in FIG. 22, the plurality of frames W1 to Wn of the data memory DM may form a plurality of groups. The respective frames of the data memory DM may be partitioned to form the plurality of groups. The respective linefill units of the data memory DM may be partitioned to form the plurality of groups.

In an embodiment of the inventive concept, similar to the data memory DM, the tag memory TM, the multiplexer unit MU1, and the comparator unit CU may be partitioned to process multiple requests in response to the multiple information MI. In another embodiment of the inventive concept, the tag frames TW1b to TWnb of the tag memory TM, the multiplexers M1b to Mnb of the multiplexer unit MU1, the comparators CP1b to CPnb of the comparison unit CU may be activated or deactivated in response to the multiple information MI.

In addition, the hit and miss determination unit HMDUb, the replacement unit RMUb, the multiplexer unit MU2b, the multiplexer unit MU3b, the multiplexer unit MU4b, the state machine SMb, the miss control unit MCUb, the linefill control unit, LCUb, and the linefill buffer LBb may be activated or deactivated in response to multiple information MI.

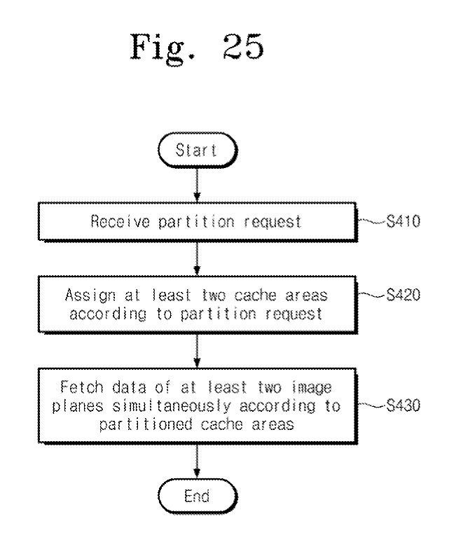

FIG. 25 is a flowchart of a method of operating the pixel cache 1265b shown in FIG. 24. Referring to FIGS. 24 and 25, at operation S410, a request to partition the pixel cache 1265b is received. The request to partition may indicate how to partition the pixel cache 1265b based on the number of requests that need to be simultaneously processed. For example, the pixel cache 1265b may recognize that the multiple information MI is stored in the special function register SFR. In an embodiment, when power is supplied to a system-on-chip or mobile apparatus including the pixel cache 1265b, the master apparatus accessing the pixel cache 1265b may transfer the multiple information MI to the pixel cache 1265b.

At operation S420, at least two cache areas are allocated according to the partition request. The pixel cache 1265b may partition the data memory DM into at least two areas based on the multiple information MI,

At operation S430, at least two image planes are simultaneously fetched according to the partitioned cache areas.

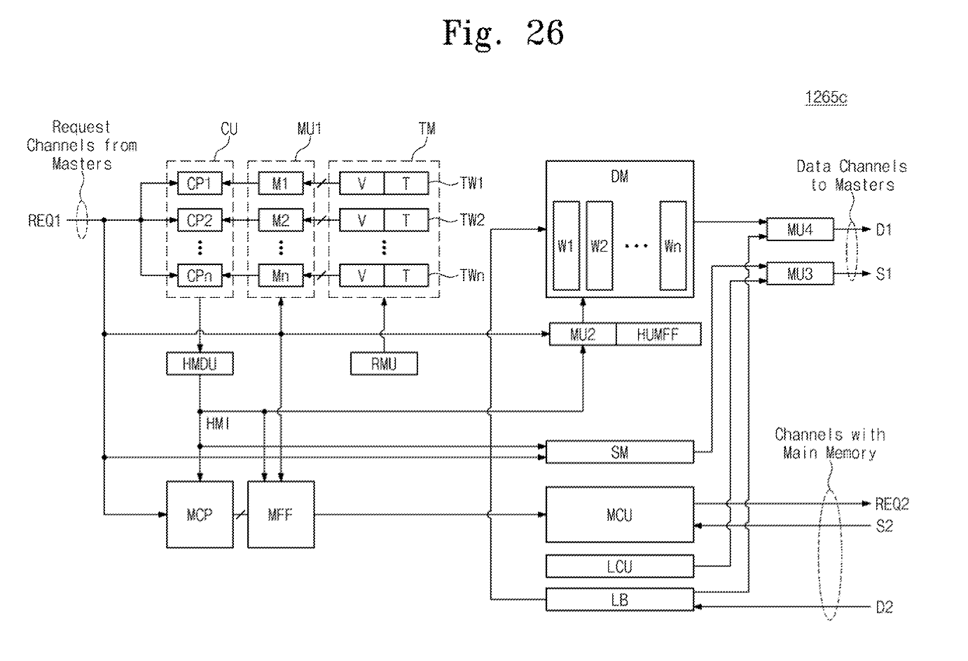

FIG. 26 is a block diagram of a pixel cache 1265c according to another embodiment of the inventive concept. Referring to FIGS. 1, 4, and 26, the pixel cache 1265c includes a data memory DM, a tag memory TM, multiplexer units MU1 to MU4, a comparison unit CU, a hit and miss determination unit HDMU, a replacement unit RMU, a state machine SM, a miss control unit MCU, a linefill control unit LCU, a linefill buffer LB, a miss comparator MCP, a miss register MFF, and a hit under miss register HUMFF. Compared to the pixel cache 1265 shown in FIG. 5, the pixel cache 1265c further includes the miss comparator MCP, the miss register MFF, and the hit under miss register HUMFF.

The miss register MFF may store the address included in the request REQ1 in response to the hit and miss information HMI. For example, if the hit and miss information HMI indicates a “miss,” the miss register MFF may store the address included in the request REQ1. The miss register MFF may include a plurality of flip-flops.

In response to the hit and miss information HMI, the miss comparator MCP may compare the address included in the request REQ1 with the register stored in the miss register MFF. In an embodiment, when the hit and miss information HMI indicates a “miss,” the miss comparator MCP may perform a comparison.

In response to the hit and miss information HMI, the hit under miss register HUMFF may store the address included in the request REQ1. In an embodiment, when the pixel cache 1265c is fetching an image plane, or the miss register MFF stores the address and the hit and miss information HMI indicates a “hit,” the hit under miss register HUMFF may store the address included in the request REQ1. The hit under miss register HUMFF may include a plurality of flip-flops.

The pixel cache 1265c may be a non-blocking cache. If the request REQ1 is determined to be a “miss,” the address included in the request REQ1 may be stored in the miss register MFF. After the address is stored in the miss register MFF, the pixel cache 1265c fetches the image plane corresponding to the address while receiving the next request REQ1. In an embodiment, the miss control unit MCU may output the request REQ2 based on the address stored in the miss register MFF.

While the image plane is being fetched by the miss control unit MCU, the next request REQ1 may be processed. If the next request REQ1 is a “hit,” the address included in the next request REQ1 may be stored in the hit under miss register HUMFF. If the next request REQ1 is a “miss,” the address included in the next request REQ1 may be stored in the miss register MFF. The image plane corresponding to the address stored in the miss register MFF may be fetched by the miss control unit MCU. The image plane corresponding to the address stored in the hit under miss register HUMFF may be outputted from the data memory DM.

If the address determined as a “miss” is already stored in the miss register MFF, the address may not be additionally stored in the miss register MFF. Such determination may be performed by the miss comparator MCP.

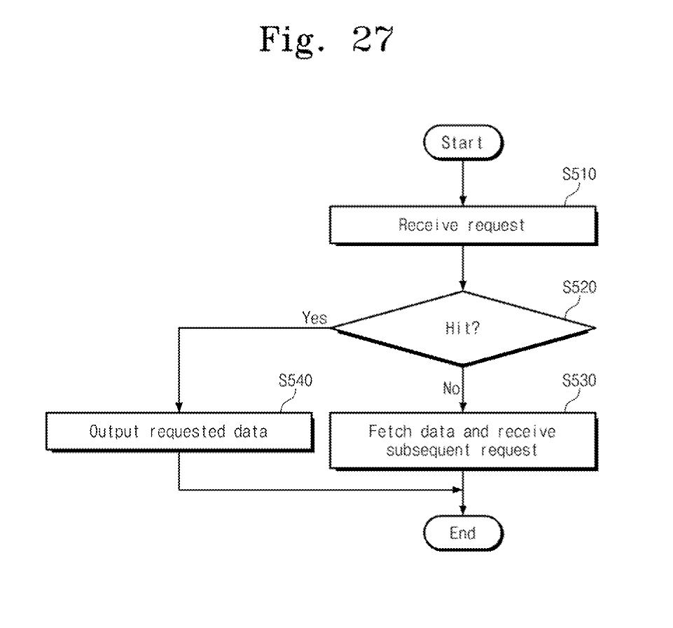

FIG. 27 is a flowchart illustrating a method of operating the pixel cache 1265c shown in FIG. 26. Referring to FIGS. 26 and 27, at operation S510, the pixel cache 1265c may receive the request REQ1.

At operation S520, it is determined whether or not the request REQ1 is a “hit”. If the received request REQ1 is a “hit,” at operation S540, the requested data is outputted. If the received request REQ1 is a “miss,” at operation S530, the requested data is fetched and the next request REQ1 is received. The operation of fetching the requested data and the operation of receiving the next request REQ1 may be concurrently performed.

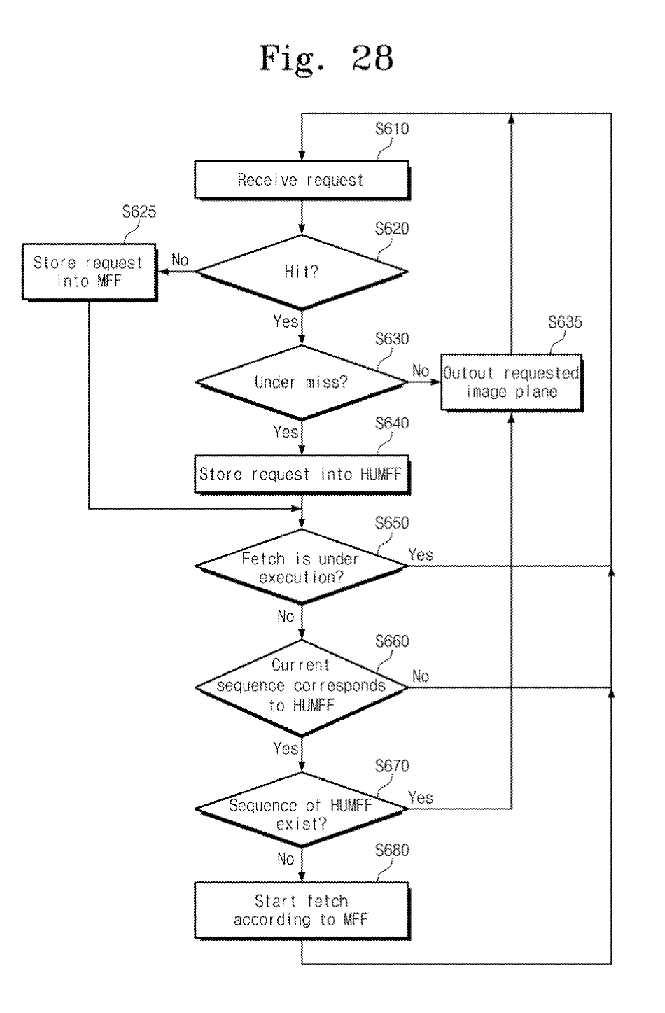

FIG. 28 is a flowchart illustrating in more detail a method of operating the pixel cache 1265c shown in FIG. 26. Referring to FIGS. 26 and 28, at operation S610, the request REQ1 is received.

At operation S620, it is determined whether or not the request REQ1 is a “hit”. If the request REQ1 is a “miss”, at operation S625, the received request REQ1 is stored in the miss register MFF. Then, operation S650 is performed. If the received request REQ1 is “hit,” operation S630 is performed.

At operation S630, it is determined whether or not the “under miss” condition exists. For example, it is determined whether a “hit” occurred during the data fetch caused by the previous “miss”. If the “under miss” condition does not exist, i.e., if no request is stored in the miss register MFF and the “hit” occurred without an image plane fetch, operation S635 is performed. At operation S635, the requested image plane is outputted. The requested data may be outputted from the data memory DM. For example, the request REQ1 may be transferred to the data memory DM through the multiplexer unit MU2 and the requested image plane may be outputted from the data memory DM.

If the “under miss” condition exists, i.e., if a request has been stored in the miss register MFF and a “hit” occurs while the image plane is being fetched, the received request REQ1 is stored in the hit under miss register HUMFF at operation S640.

At operation S650, it is determined whether or not the image plane is being fetched. If the image plane is being fetched, the fetch may be performed according to the request stored in the miss register MFF or the hit under miss register HUMFF. Thus, without referring to the miss register MFF or the hit under miss register HUMFF, the next request REQ1 is performed at operation S610.

If the image plane is not being fetched, the fetch may be performed according to the request stored in the miss register MFF or the hit under miss register HUMFF. At operation S660, it is determined whether the stored request sequence exists. The request sequence may be the sequence of the requests that have been received and stored in the miss register MFF or the hit under miss register HUMFF. The request sequence may include information on the order of the stored requests. The request sequence may be managed by the state machine SM.

If no stored request sequence exists, then there is no request stored in the miss register MFF or the hit under miss register HUMFF. Thus, without referring to the miss register MFF or the hit under miss register HUMFF, the next request REQ1 is processed at operation S610.

If the stored request sequence exists, it is determined at operation S670 whether or not the current request sequence corresponds to the hit under miss register HUMFF. If the current request sequence corresponds to the hit under miss register HUMFF, the requested image plane is outputted at operation S635. Then, at operation S610, the next request is processed.

If the current request sequence does not correspond to the hit under miss register HUMFF, the fetch begins at operation S680 according to the request stored in the miss register MFF.

The operations S610 through S680 may be continuously performed as long as power is supplied to the pixel cache 1265c.

The received request REQ1 may be processed through the operations S610 to S640. A “miss” request REQ1 is stored in the miss register MFF. A “hit under miss” request REQ1 is stored in the hit under miss register HUMFF. The “hit” request REQ1 causes the image plane to be outputted. Even if a “miss” request REQ1 is received, the pixel cache 1265c may store the received request REQ1 in the miss register MFF and continue to process the next request.

Through the operations S650 to S680, the “under miss” condition is processed. When the image plane is not being fetched, the image plane will be fetched according to the request sequence stored in the miss register MFF or the hit under miss register HUMFF. When the fetch of a single image plane is completed, the fetch of the image plane corresponding to the next request of the sequence is performed.

That is, through the operations S610 to S640, either the image plane is outputted, or the request REQ1 is stored in the miss register MFF or the hit under miss register HUMFF. The operations S610 to S640 may correspond to receiving the request REQ1 in real time while using the miss register MFF or the hit under miss register HUMFF as a buffer.

Through the operations S650 to S680, the image plane is fetched in accordance with the request stored in the miss register MFF or the hit under miss register HUMFF. The fetched image plane is outputted and the request corresponding to the fetched image plane is deleted from the miss register MFF or the hit under miss register HUMFF. The operations S650 to S680 may be performed to process a request stored in the miss register MFF or the hit under miss register HUMFF and clear the miss register MFF or the hit under miss register HUMFF.

In FIG. 28, operations S610 to S680 are performed as a single method. However, embodiments of the inventive concept are not limited to a single method. In an embodiment of the inventive concept, operations S610 to S640 may be a method of processing the received request REQ1, while operations S650 to S680 may be another method of processing of requests stored in the registers. These methods may be performed independently from each other.

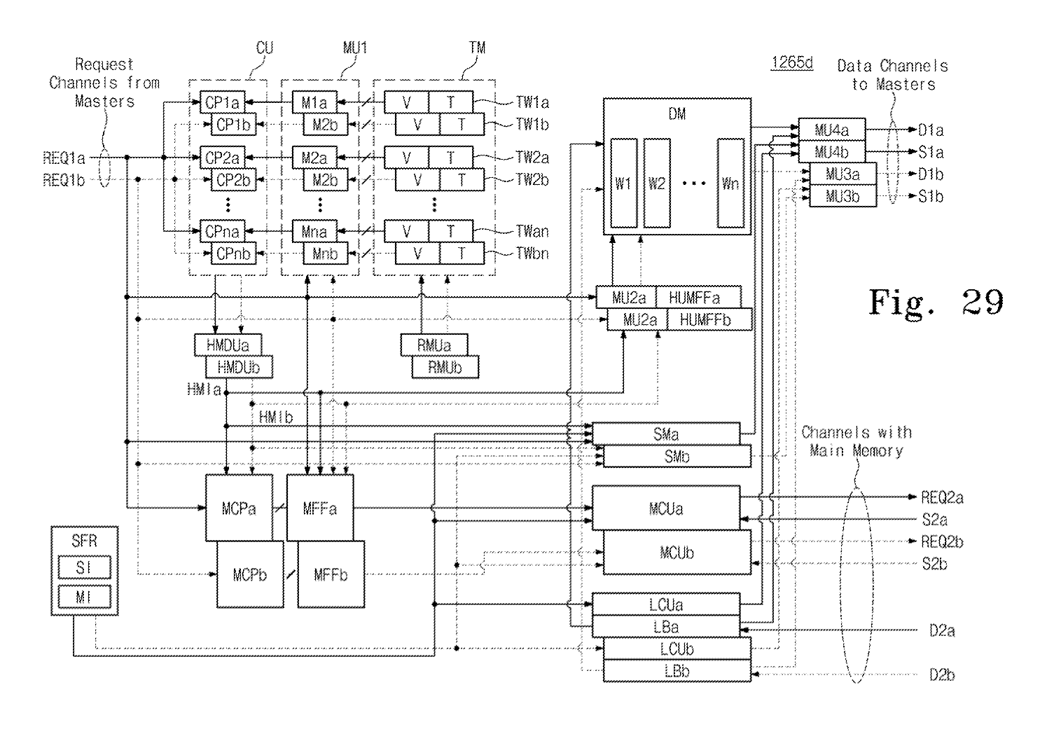

FIG. 29 is a block diagram of a pixel cache 1265d according to another embodiment of the inventive concept. In an embodiment, the pixel cache 1265d may be provided as a combination of the pixel caches 1265, 1265a, 1265b, and 1265c respectively shown in FIGS. 5, 20, 24, and 26. The pixel cache 1265d may store the image plane in a linefill unit. The size of the image plane or the linefill unit may be adjusted according to the size information SI stored in the special function register SFR. The pixel cache 1265d may simultaneously process a number of requests REQ1a and REQ1b based on the multiple information MI. The pixel cache 1265d may be a non-blocking cache.

As shown in FIG. 29, at least two pixel caches of the pixel caches 1265, 1265a, 1265b, and 1265c respectively shown in FIGS. 5, 20, 24, and 26 may be combined.

In an embodiment, is pixel cache 1265d is set to simultaneously process at least two requests REQ1 and REQ2, the size of the image plane or the linefill unit may vary for each request.

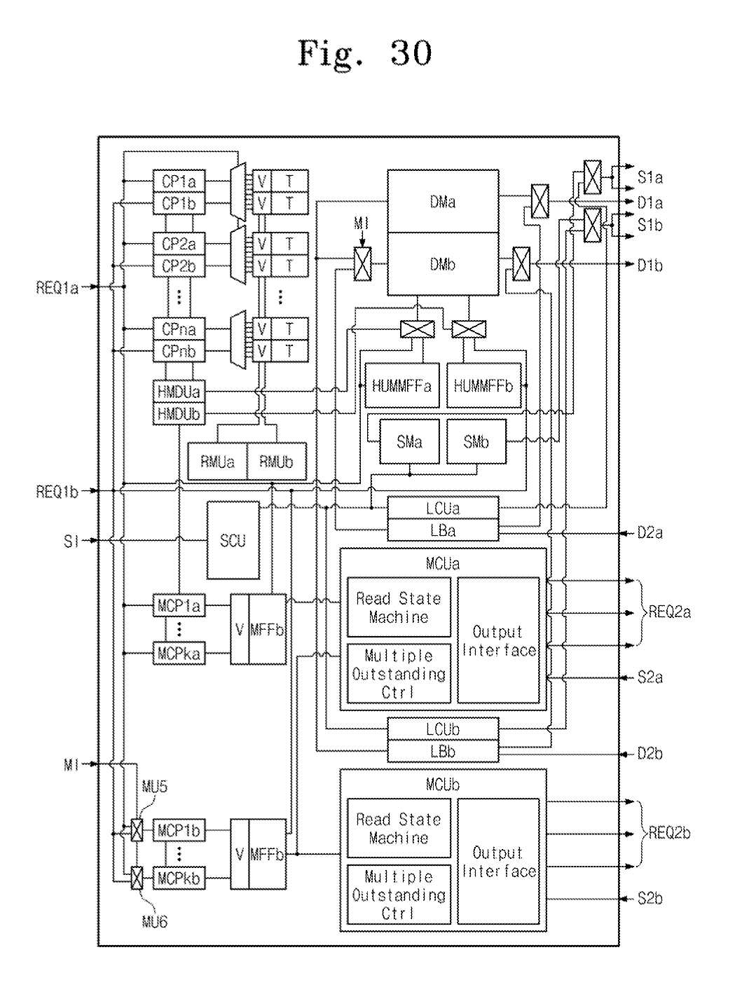

FIG. 30 is a block diagram of a pixel cache 1265e according to another embodiment of the inventive concept. Compared to the pixel cache 1265d in FIG. 29, the pixel cache 1265e further includes multiplexer units MU5 and MU6. The multiplexer units MU5 and MU6 may operate in response to mode information MI.

The mode information MI may be used to determine whether to activate the miss comparators MCP1b to MCPkb and the miss register MFFb, and whether to activate the data memory DMb. In an embodiment, if the data memory DMb is deactivated, the data memory DMb may be managed as the part of the data memory DMa.

The size control unit SCU may manage the size of the linefill unit of the pixel cache 1265e based on the size information SI. In an embodiment, the size information SI and the mode information MI may be provided to the pixel cache 1265e. The special function register SFR storing the size information SI and the mode information MI may be external to the pixel cache 1265e.

Each of the miss control units MCUa and MUCb includes an interface communicating with an external channel, a read state machine, and a multiple execution control unit. The read state machine may transfer the reading requests REQ2a and REQ2b to the main memory 1300 shown in FIG. 1. The multiple execution control unit may control the period of the image plane fetch. In an embodiment, if multiple “misses” occur, multiple image plane fetches may be required. A bottleneck effect may arise in the main memory 1300 when many image plane fetches are performed during a short time period. The multiple execution control unit allows the main memory 1300 to avoid the bottleneck effect by adjusting the period or frequency of the image plane fetches.

According to embodiments of the inventive concept, a pixel cache fetches data using an image plane including at least two rows and at least two columns of pixels. Thus, there is provided a pixel cache, a method of operating the pixel cache, and an image processing device including pixel cache, which optimizes data management of spatially localized images.

The inventive concept of the present disclosure is described with reference to an image processing device. An image processing device according to the inventive concepts may include at least one of various image processing hardwares such as a graphics processing unit GPU, a video codec, a display controller, an image signal processor ISP, etc. That is, a pixel cache according to the inventive concept may be provided as an element of at least one of the various image processing hardwares such as a GPU, video codec, display controller, image signal processor ISP, etc.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of operating a pixel cache, said pixel cache comprising a plurality of linefill units and configured to fetch an image stored in a main memory, said method comprising:
receiving a request for data of one or more image planes from an image processing device; and
if the request for at least one image plane is determined as a “hit”, outputting the requested data of the at least one image plane and fetching the requested data from the main memory of at one other image plane determined as not a “hit”,
wherein the “hit” is determined for each image plane of the one or more image planes based on whether data of the image plane is stored in one of the plurality of linefill units, and
wherein the image plane includes at least two rows and at least two columns of pixels and has a size substantially identical to a capacity of the linefill unit.

2. The method of claim 1, further comprising:
storing data of an image plane of the image stored in the main memory in one of the plurality of linefill units before receiving of the request,
wherein data of the image plane stored in the linefill unit is output to the image processing device,
wherein the linefill unit is a unit of data stored or outputted at one time in the pixel cache.

3. The method of claim 1, wherein the image plane stored in the linefill unit is fetched from at least two parts of the main memory, addresses of the at least two parts in the main memory being non-consecutive, and each of the at least two parts having at least two consecutive addresses in the main memory.

4. The method of claim 1, further comprising:
outputting the fetched data of the at least one other image plane.

5. The method of claim 1,
wherein receiving a request includes receiving the request for data of two or more image planes from the image processing device.

6. The method of claim 5,
wherein the request includes an address of a reference point related to the two or more image planes and a horizontal width from the reference point.

7. The method of claim 5,
wherein the request includes an address of a reference point related to the two or more image planes and a vertical length from the reference point.

8. The method of claim 5,
wherein the request includes an address of a reference point related to the two or more image planes and a horizontal width and a vertical length from the reference point.

9. The method of claim 5,
wherein the request includes addresses of first and second reference points related to the two or more image planes.

10. The method of claim 5, wherein the two or more requested image planes are adjacent in the image.

11. The method of claim 2, further comprising:
before storing the data, adjusting a capacity of the linefill unit.

12. The method of claim 2, further comprising:
before storing the data, partitioning the plurality of linefill units into a first linefill group and a second linefill group.

13. The method of claim 12, wherein storing the data comprises:
storing first data of a first image plane of a first image into a first linefill unit of the first linefill group; and
storing second data of a second image plane of a second image different from the first image into a second linefill unit of the second linefill group,
wherein storing the first data into the first linefill unit and storing the second data into the second linefill unit are simultaneously performed.

14. The method of claim 1, wherein if the request for a first image plane is determined as not a “hit,” the requested data of the first image plane is fetched from the main memory while receiving a request for data of a second image plane from the image processing device.

15. A pixel cache comprising:
a data memory that includes a plurality of frames, each frame including a plurality of linefill units configured to store data;
a tag memory that includes a plurality of tag frames corresponding to the plurality of frames respectively, each tag frame including a plurality of tag lines respectively corresponding to the plurality of linefill units of each frame; and
a miss control unit configured to request data of an image plane of an image stored in a main memory external to the pixel cache,
wherein the data of the image plane received from the main memory is stored in a linefill unit of the data memory, and address information of the data of the image plane received from the main memory is stored in a tag line of the tag memory,
a capacity of the linefill unit corresponds to a size of the image data being stored or outputted at one time in the pixel cache, and
the image plane includes at least two rows and at least two columns of pixels and has a size substantially identical to the capacity of the linefill unit.

16. The pixel cache of claim 15, further comprising:
a register configured to store information on the capacity of the linefill unit, wherein the capacity of the linefill unit is adjusted according to the information stored in the register.

17. The pixel cache of claim 16,
wherein if the capacity of the linefill unit is to be increased, at least two linefill units from at least two different frames of the tag memory are combined to form a combined linefill unit.

18. The pixel cache of claim 15, further comprising:
a register configured to store on a umber of images being simultaneously processed,
wherein the miss control unit is configured to simultaneously request from the main memory a number of image planes that respectively correspond to the number of images being simultaneously processed.

19. The pixel cache of claim 15, further comprising:
a hit and miss determination unit configured to receive a request for data of a first image plane from an image processing device, and to determine whether the requested data of the first image plane exists in the data memory by searching the tag memory; and
a register configured to store a request determined as a “miss” request by the hit and miss determination unit,
wherein the miss control unit is configured to request data of a second image plane from the main memory according to the miss request stored in the register, and
after the miss request is stored in the register, the hit and miss determination unit is configured to receive a request for data of a next image plane and to determine whether the requested data of the next image plane exists in the data memory.

20. The pixel cache of claim 19, further comprising a second register configured to store a request determined as “hit” request by the hit and miss determination unit while the miss control unit requests the data of the second image plane from the main memory.

21. An image processing device comprising:
a pixel cache; and
a processing unit configured to request data of an image plane from the pixel cache and to perform image processing on the data of the image plane received from the pixel cache,
wherein the pixel cache includes,
a data memory that includes a plurality of frames, each frame including a plurality of linefill units configured to store data;
a tag memory that includes a plurality of tag frames that respectively correspond to the plurality of frames, each tag frame including a plurality of tag lines respectively corresponding to the plurality of linefill units of each frame; and
a miss control unit configured to request the data of the image plane from an external main memory according to the request from the processing unit,
wherein the image plane data received from the main memory is stored in a linefill unit of the data memory, and address information of the data of the image plane received from the main memory is stored in a tag line of the tag memory,
a capacity of the linefill unit corresponds to a size of a image data being stored or outputted at one time in the pixel cache, and
the image plane includes at least two rows and at least two columns of pixels and has a size substantially identical to the capacity of the linefill unit.
